(19) United States
(12) Patent Application Publication
(10) Pub. No.: US 2014/0330700 A1
(43) Pub. Date: Nov. 6, 2014

(54) MULTIPLE OPEN ORDER RISK MANAGEMENT AND MANAGEMENT OF RISK OF LOSS DURING HIGH VELOCITY MARKET MOVEMENT

(71) Applicant: Chicago Mercantile Exchange Inc., Chicago, IL (US)

(72) Inventors: Ari L. Studnitzer, Chicago, IL (US); Amy McCormick, Chicago, IL (US)

(21) Appl. No.: 14/334,048

(22) Filed: Jul. 17, 2014

Related U.S. Application Data
(63) Continuation-in-part of application No. 13/324,768, filed on Dec. 13, 2011.
Application No. 13/324,768 is a continuation of application No. 12/437,878, filed on May 8, 2009, now Pat. No. 8,086,527.
Application No. 12/437,878 is a continuation of application No. 11/600,984, filed on Nov. 17, 2006, now Pat. No. 7,734,538.
(60) Provisional application No. 61/987,933, filed on May 2, 2014.
(60) Provisional application No. 60/738,246, filed on Nov. 18, 2005.

(51) Int. Cl. G06Q 40/04

(52) U.S. Cl. CPC G06Q 40/04
USPC 705/37

(57) ABSTRACT

The disclosed embodiments relate to a mechanism which may restrict or otherwise manage the extent of exposure of any particular market participant within the price movement threshold of a market protection system which interrupts market activity during extreme events, as well as to a mechanism for controlling risk of loss which acts to reduce or otherwise manage a market participant's ability to concentrate their exposure, or risk of loss, within a range of price levels and/or within correlated products that could be executed upon before the market participant, or other entity responsible for the activities thereof, e.g. a risk manager, has an opportunity to react to rapid market movement. Such a mechanism, once the market protection system had activated, e.g. by placing the market in reserve, may permit the market participant, or other party, the opportunity to modify or cancel unexecuted orders to mitigate potential losses.

### REFERENCE TO RELATED APPLICATIONS

This application claims the benefit of the filing date under 35 U.S.C. §119(e) of U.S. Provisional Application Ser. No. 61/987,933 filed May 2, 2014, which is hereby incorporated by reference. This application is a continuation-in-part under 37 C.F.R. §1.53(b) of U.S. patent application Ser. No. 13/324,786 filed Dec. 13, 2011, which is a continuation under 37 C.F.R. §1.53(b) of U.S. patent application Ser. No. 12/437,878 filed May 8, 2009, now U.S. Pat. No. 8,086,527, which is a continuation of U.S. patent application Ser. No. 11/600,984 filed Nov. 17, 2006, now U.S. Pat. No. 7,734,538, which claims the benefit of the filing date under 35 U.S.C. §119(e) of U.S. Provisional Application Ser. No. 60/738,246 filed Nov. 18, 2005, all of which are hereby incorporated by reference.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. Anyone standing in or near the trading pit may be privy to the trades taking place, i.e. both who is trading and what they are trading, allowing, for example, one participant to derive and/or undermine another participant's trading strategy and thereby garner an unfair advantage or otherwise skew the market. Electronic trading systems, in contrast, ideally attempt to offer a more efficient, fair and balanced market where market prices reflect a true consensus of the value of traded products among the market participants, where the intentional or unintentional influence of any one market participant is minimized if not eliminated, and where unfair or inequitable advantages with respect to information access are minimized if not eliminated.

The speed in which trades are executed through electronic trading systems provide many benefits. Electronic trading systems can facilitate a large number of market transactions. The greater the number of market transactions, the greater a market's liquidity. In liquid markets, prices are driven by competition; prices reflect a consensus of an investment's value; and trading systems provide a free and open dissemination of information, With the advent of improved computational and communications capabilities, the speed and efficiency with which traders may receive information and trade in electronic trading systems has greatly improved. Algorithmic and high frequency trading utilize computers to quickly analyze market information and place trades allowing traders to take advantage of even the smallest movements in prices.

Unfortunately, this improved speed and efficiency also improves the speed at which problems may occur and propagate, such as where the market ceases to operate as intended, i.e. the market no longer reflects a true consensus of the value of traded products among the market participants. Such problems are typically evidenced by extreme market activity such as large changes in price, whether up or down, over a short period of time or an extreme volume of trades taking place.

In particular, traders, whether human or electronic, may not always react in a rational manner, such as when presented with imperfect information, when acting in a fraudulent or otherwise unethical manner, and/or due to faulty training or design. For example, while communications technologies may have improved, inequities in access to information and opportunities to participate still exist, which may or may not be in compliance with legislative, regulatory and/or ethical rules, e.g. some traders receive information before other traders, some traders may be able to place trader orders more quickly than others. In many cases, irrational trader behavior may be triggered by a market event, such as a change in price, creating a feedback loop where the initial irrational reaction may then cause further market events, such as a continued price drop, triggering further irrational behavior and an extreme change in the price of the traded product in a short period of time. High speed trading exacerbates the problem as there may be little time for traders, or those overseeing them, to contemplate their reactions before significant losses may be incurred. Furthermore, improved communication among traders facilitates propagation of irrational behavior in one market to other markets as traders in those other markets react to the results of the irrational behavior.

To mitigate risk and ensure a fair and balanced market, electronic trading systems need to provide mechanisms to rapidly detect and respond to situations where a market is not operating in a fair and balanced manner or otherwise where the market value is not reflective of a true consensus of the value of the traded products among the market participants.

### BRIEF DESCRIPTION OF THE DRAWINGS

FIG. 1 depicts an illustrative computer network system that may be used to implement aspects of the present invention

FIG. 2 depicts a block diagram of an exemplary implementation of the system of FIG. 1 for administering futures contracts, according to one embodiment.

FIG. 3 depicts a flow chart showing operation of the system of

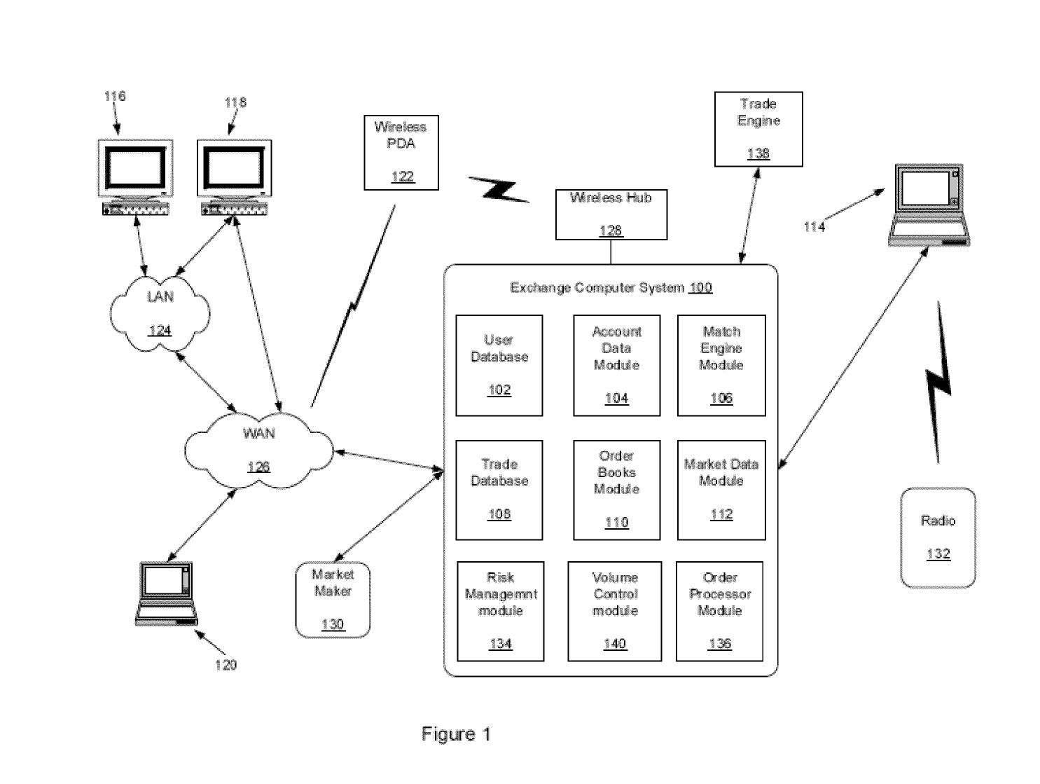

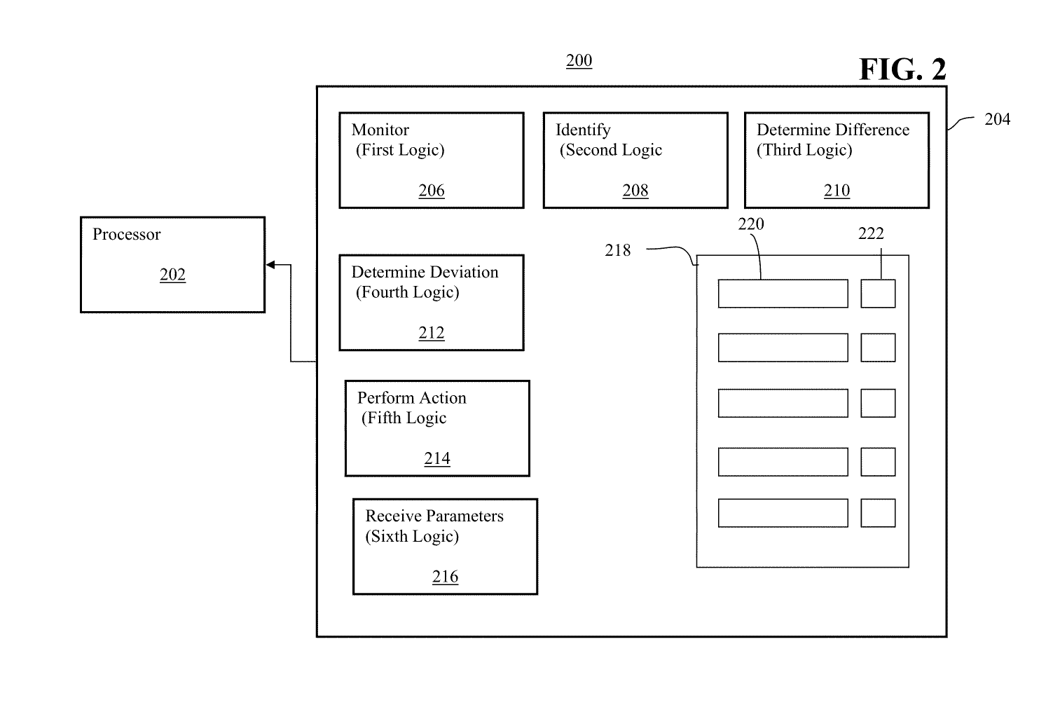

FIGS. 1 and 2.

FIG. 4 shows an illustrative embodiment of a general computer system for use with the system of FIGS. 1 and 2.

FIG. 5 shows representations of the operation of the system of FIG. 2.

FIG. 6 shows a graph of exemplary operation of the system of FIG. 2.

FIG. 7 depicts a block diagram of a system of managing risk undertaken by market participants transacting via an Exchange according to one embodiment.

FIG. 8 depicts a flow chart showing operation of the system of FIG. 7.

FIG. 9 depicts a block diagram of a system of managing risk undertaken by market participants transacting via an Exchange according to another embodiment

FIG. 10 depicts a flow chart showing operation of the system of FIG. 9.

### DETAILED DESCRIPTION

The disclosed embodiments relate to mechanisms to rapidly detect and respond to situations where a market is not operating in a fair and balanced manner or otherwise where, for example, the market value is not reflective of a true or rational consensus of the value of the traded products among the market participants. In particular, the disclosed embodiments continually scan for, rapidly detect and respond to extreme changes, either up (“spike”) or down (“dip”) in the market where a precipitous market move/change occurs. Once detected, the disclosed embodiments may respond by taking an action such as notifying the operator of the exchange, such as the Global Control Center (“GCC”) of the Chicago Mercantile Exchange (“CME”), placing the market in a paused or reserved state, described in more detail below, establishing permanent or temporary trade price limitations, or other actions, or combinations thereof, to mitigate the effects of the extreme change, so as to, for example, slow down the market or otherwise allow traders time to adequately analyze and react to market conditions.

The disclosed embodiments further relate to a mechanism which may restrict or otherwise manage the extent of exposure of any particular market participant within the price movement threshold of the market protection system described herein, as well as to a mechanism for controlling risk of loss, referred to as a “credit control” mechanism, which acts to reduce or otherwise manage a market participant's ability to concentrate their exposure, or risk of loss, within a range of price levels and/or among correlated products that could be executed upon before the market participant, or other entity responsible for the activities thereof, e.g. a risk manager, has an opportunity to react to rapid market movement. Such a mechanism, once the market protection system had activated, e.g. by placing the market in reserve, may permit the market participant, or other party, the opportunity to modify or cancel unexecuted orders to mitigate potential losses.

Systems exist to handle extreme market changes due to the execution of stop orders as, in a futures market that has few resting orders but many stop orders, an order executed at a limit price can cause a cascading execution of buy or sell stop orders. The triggering and election of these stop orders can seem almost instantaneous lowering the value of a market in just a few seconds. The problem may occur when one or more trades bring many stop orders into the market. A fast execution of these stop orders may prevent opposite side orders from entering the market, preventing buyers from competing against other buyers and sellers from competing against other sellers. See, for example, U.S. Pat. Nos. 8,103,576 and 8,112,347 and U.S. Patent Publication No. 2005/0108141 A1, herein incorporated by reference in their entirety. However, extreme market moves can occur that are not precipitated by Stop Orders, thereby making such “Stop Price Logic” ineffectual. Accordingly, the disclosed embodiments detect and respond to extreme market changes regardless of whether or not they may be precipitated by a stop order.

While the disclosed embodiments may be described with reference to their applicability to electronic trading systems which trade futures contracts, and derivatives thereof, it will be appreciated that they may be applicable to any electronic trading system, e.g. which trade derivatives, equities or other products.

It will be appreciated that a trading environment, such as a futures exchange as described herein, implements one or more economic markets where rights and obligations may be traded. As such, a trading environment may be characterized by need to maintain market integrity, transparency, predictability, fair/equitable access and participant expectations with respect thereto. For example, an exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g. that transactional integrity and predictable system responses are maintained.

Generally, the disclosed embodiments determine when a market for a particular product moves too quickly, either up or down, in too short a period of time, e.g. the velocity of the market exceeds a defined threshold limit. The market parameter(s), or derivations thereof, monitored for movement, the basis for determination of a qualifying magnitude of movement, and/or the duration of the requisite period of time over which a qualifying change may occur, may be configurable, as will be described, and implementation dependent, so as to allow the disclosed embodiments to balance performance versus the ability to accurately discriminate between extreme movements in the market which are reflective of valid market operation from those that are not. While the disclosed embodiments will be described with respect to a product by product or market by market implementation, e.g. implemented for each market/order book, it will be appreciated that the disclosed embodiments may be implemented so as to apply across markets for multiple products traded on one or more electronic trading systems, such as by monitoring an aggregate, correlated or other derivation of the relevant indicative parameters as described herein.

The disclosed embodiments effectively periodically sample, derive or otherwise measure a parameter indicative of the market value of a product, such as a futures contract. The market for the product may also be referred to as an order book. Parameters indicative of the market value include the most recent price at which a trade was matched or quantity associated therewith, the most recently received, i.e. via an incoming order, bid price or quantity associated therewith, the most recently received, i.e. via an incoming order, ask price or quantity associated therewith, the current lowest ask price for an unmatched trade order resting in the order book or quantity associated therewith, the current highest bid price for an unmatched trade order resting in the order book or quantity associated therewith, combinations thereof or derivations therefrom, such as volatility, average, difference from historical values or other parameters, statistical or otherwise, indicative of the conditions under which the market is operating. When monitoring price based parameters, the values associated therewith may be measured in ticks, points or other metrics. Time may be measured in seconds or milliseconds, or other increments. When sampling, deriving or otherwise measuring a parameter that is derived from an incoming trade order, such as the order price, every trade may be sampled or otherwise analyzed for comparison as will be described.

The current sampled, derived or measured parameters are compared with one or more sampled, derived, measured or computed values, or ranges thereof, representative of each interval or slice of time preceding the current sample, the collection of which may be referred to as a window as well as, in one embodiment, with some or all of the previous values sampled, derived or measured within the current interval. FIG. 5 shows diagrams depicting various representations of the manner in which samples are obtained and compared according to one embodiment. The disclosed embodiments sample or otherwise derive the market value parameter (Pₙ), or a high (Vₕᵢ) and/or low (Vₗₒ) value thereof, at a particular frequency, e.g. upon the elapse of a duration of time or interval/slice such as 1 second (iₙ) representative of the value over the duration of the interval, e.g. the highest and/or lowest value over the interval. Initially, when a trading period commences or otherwise there is no market history, e.g. the market opens, or otherwise when operation of the disclosed embodiments is initiated (or after a sufficient period of market inactivity as will be described below), the first sample of the market value parameter (P₁) may be defined, such as statically, or otherwise derived, such as based on the parameter value at the close of the prior trading period, the first value sampled, derived or measured upon commencement of the trading period, or based on some other method such as derivation of an indicative opening price. During each interval or time slice, the sampled market parameter value, e.g. of each incoming trade, is compared with one or more parameters indicative of the market value determined during each of a defined number of preceding intervals described above, as well as, in one embodiment, each preceding market parameter value sampled, derived or measured during the current interval. In one embodiment, the sampled or derived parameter obtained during the current interval may be compared with comparative parameters/values such as the values of the previously acquired samples of the requisite preceding intervals, as well as the preceding values of the current interval. In an alternative embodiment, at each interval other comparative parameters are determined, such as the highest and lowest value of the monitored parameter over the duration of particular interval, to which the sampled parameter obtained during the current interval is compared. For the current interval, such highest and lowest values are determined as each market parameter is sampled, measured or derived, for comparison with the most current market parameter value.

As noted above, the number of preceding intervals/slices which are subject to comparison is configurable and effectively defines a rolling window of time where older intervals are discarded as time moves forward, e.g. new intervals commence. In one implementation, this rolling time window may be structured or otherwise conceptualized as multiple overlapping sampling/monitoring windows or threads, referred to as overlapping time buckets, (bₙ) 604 which run for a defined period of time and where a new time bucket is commenced, the market value parameter is sampled or otherwise determined or derived, upon each elapse of the interval time i, and time buckets commenced at a time older than the defined number of preceding intervals are discarded. The number of active time buckets, the duration thereof, and the interval at which buckets are started then defines the window of time over which, or otherwise how far back, the disclosed embodiments operate. In one embodiment, if there has been no market activity during any of the intervals within the time window, the disclosed system considers the next market event to be akin to the start of a new trading period as described above.

It will be appreciated that whether the disclosed embodiments are conceptualized as overlapping time buckets or as a duration of time defined by intervals or slices, as described, or in any other manner, may be implementation dependent and all such conceptualizations, now or later developed, are contemplated herein.

In one embodiment, the time window over which an incoming order is compared may be defined order by order, e.g. based on the incoming order. That is, each incoming order has its own time window wherein the incoming order is compared with values within its associated time window. For example, each incoming order may be compared with a preceding order received in the window preceding the current order. As described elsewhere, the window may be specified as an amount of time or a number of intervals.

As noted above, each sampled, derived or measured value obtained during the current interval or slice is compared with one or more comparative values determined for each preceding interval/slice with the defined time range of the current time, referred to as the “time window,” as well as, in one embodiment, each preceding sampled, derived or measured value, or the highest and or lowest thereof, of the current interval. If the sampled value deviates, i.e. is above or below, from any of the comparative values by a threshold amount, which may be configurable and may be zero, the disclosed embodiments may indicate a qualifying event and indicate that action should be taken. In one implementation, the threshold amount is not less than 1. The threshold amount may be statically or dynamically configured and reflects the magnitude of market movement between compared values that may be tolerated, i.e. the threshold amount delineates a magnitude of movement/change, up or down, considered to be normal for the market and avoids, for example, placing a market in a reserved state that is not, in fact, under duress. This comparison may be represented by the chart 606 shown in FIG. 6 which demonstrates, according to one embodiment, how the sampled parameters obtained during the interval i₄ are compared with each of the preceding values sampled in interval i₄ as well as the values P₄, P₃, P₂ and P₁, or the high (Vₕᵢ) or low (Vₗₒ) values thereof, of the preceding intervals. As shown in this chart 606, the disclosed embodiments may effectively measure the steepness, which may be positive, as shown in the Figure, or negative, of the slope between the market value at the current interval and each of the preceding intervals where a qualifying event may be determined when the steepness of the slope, or angle or other value representative thereof, whether positive or negative, exceeds, or otherwise deviates from, a defined threshold value indicative, for example, of an extreme market movement.

In one embodiment, rapid oscillation or thrashing of the market value within the threshold values may also be detected and may also signify that the market is not operating properly, triggering the remedies described herein.

In one embodiment, the interval width, referred to below also as the duration of time or time slice length, may be dynamic and may vary interval to interval such as based on market activity, e.g. volume or volatility. For example, an interval may be defined as every 10 milliseconds or after 10 orders have been received. As the comparative values computed at each interval are representative of the activity during that interval, the amount of activity aggregated together may thereby be normalized. In the case of dynamic interval widths, the time window over which values are compared, as described herein, may be specified in terms of an amount of time, rather than a number of intervals, so that the window may be a constant size even though the interval size may vary.

When a qualifying event has been determined, as noted above, the disclosed embodiments may take, or otherwise cause, an action to occur. This action may include alerting the operator of the electronic trading system or exchange, such as the GCC of the CME, placing the market in a reserved state whereby orders may be received and price discovery may occur but matching of trades is otherwise suspended, or institute one or more temporary or permanent limits, such as price limits, e.g. a maximum price and/or minimum price, wherein only trades at prices within the limit(s) are allowed, or combinations thereof. In an alternate embodiment, other actions may include enabling additional liquidity, i.e. trading opportunities, for the particular product, such as by temporarily or permanently enabling implied opportunities whereby, for example, additional liquidity may be found in markets for combination products, e.g. spreads, involving the particular product.

With respect to placing the market in a reserved or paused state, while an instrument may not trade when it is reserved; price discovery may still occur, e.g. an indicative opening price of that instrument may be derived and disseminated to the market. The indicative opening price may reflect the price the instrument would be trading at if the market were open. Placing an instrument in a reserved state allows market participants to enter additional orders that adjust the indicative opening price to a level that reflects buyers competing with other buyers and sellers vying against other sellers. The present embodiments may temporarily suspend trading until the market is adjusted within a threshold range, or when a period of time lapses. The period of time may vary in length in relation to the time of day, the product traded, market volatility and/or any other relevant market condition or combination of market conditions. Similarly, the threshold range may vary by the product and/or the time of day. It will be appreciated that the indicative opening price determined when the market is taken out of the reserved state, or a sampled, derived or measured value thereof, may be used as the initial comparative value(s) by the disclosed embodiments as described above upon resumption of trading.

Because market participants may not be aware that a product or an instrument is reserved due to the large volume of messages sent over an electronic trading system or because the market participants are no longer trading, the present system and method also may encompass independent communication systems to convey information, warnings, or alerts about an instrument in a reserved state. Such systems can include devices that send and/or receive messages via telecommunication or wireless links such as portable phones, personal digital assistants (“PDAs”), and/or electronic mail devices, devices that send and/or receive images and can print them on a tangible media such as faxes, etc. Preferably, these systems make market participants aware of the state of the market in a narrow timeframe. It will be appreciated that the length of time for which the market may be temporarily held in a reserved state is implementation dependent and may be configurable, statically or dynamically, and further may vary from market to market. Once the market is reopened, or otherwise taken out of reserved state, the disclosed embodiments may be re-enabled to continue monitoring the market as described herein.

It will be appreciated that other systems designed to detect and respond to extreme market changes may respond by merely setting a hard price limit, i.e. minimum or maximum depending upon the direction of the extreme movement, only within which trades are allowed to occur. However, setting either a maximum or minimum price limit and continuing to allow trading may not address the underlying problem which caused the extreme market movement and the market may reverse and undergo an extreme movement away from the set limit, such as due to the reaction of algorithmic trading systems. In contrast, the disclosed embodiments may place the market in a reserved state whereby trades are not allowed but price discovery can still occur. This effectively slows down the market and enables traders to analyze the market and temper their reactions thereto.

In accordance with aspects of the disclosure, systems and methods are disclosed for detecting and responding to extreme market movements as well as establishing risk management/credit controls which may operate in concert therewith. The disclosed embodiments are preferably implemented with computer devices and computer networks, such as those described with respect FIG. 4, that allow users, e.g. market participants, to access exchange trading information. It will be appreciated that the plurality of entities utilizing the disclosed embodiments, e.g. the market participants, risk managers, market makers, brokers, dealers, etc., may be referred to by other nomenclature reflecting the role that the particular entity is performing with respect to the disclosed embodiments, and may refer to a corporate or organizational entity and/or to an employee or agent thereof, and that a given entity may perform more than one role depending upon the implementation and the nature of the particular transaction being undertaken, as well as the entity's contractual and/or legal relationship with another market participant and/or the exchange. An exemplary trading network environment for implementing trading systems and methods is shown in FIG. 1. An exchange computer system 100 receives orders and transmits market data related to orders and trades to users, e.g. market participants, such as via computer devices 114, 116, 118, 120 and 122, as will be described below, coupled with the exchange computer system 100. As used herein, an exchange 100 includes a place or system that receives and/or executes orders for traded products.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop or other computers, such as the computer 400 described below with respect to FIG. 4. A user database 102 may be provided which includes information identifying market participants, e.g. traders and other users of exchange computer system 100, such as account numbers or identifiers, user names and passwords. An account data module 104 may be provided which may process account information that may be used during trades and, as will be described below, may be used to store credit data for use in application of the described credit controls by the risk management module 134 described below. A match engine module 106 may be included to match bid and offer prices and may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices for one or more products. A market data module 112 may be included to collect market data and prepare the data for transmission to users. A risk management module 134 may be included to compute and determine a user's risk utilization in relation to the user's defined risk thresholds as will be further described below. An order processing module 136 may be included to decompose delta based and bulk order types for processing by the order book module 110 and/or match engine module 106. A volume control module 140 may be included to, among other things, control the rate of acceptance of mass quote messages.

The trading network environment shown in FIG. 1 includes exemplary computer devices 114, 116, 118, 120 and 122 which depict different exemplary methods or media by which a computer device may be coupled with the exchange computer system 100 or by which a user/market participant may communicate, e.g. send and receive, trade or other information therewith. It will be appreciated that the types of computer devices deployed by market participants and the methods and media, including wired and/or wireless media, by which they communicate with the exchange computer system 100 is implementation dependent and may vary and that not all of the depicted computer devices and/or means/media of communication may be used and that other computer devices and/or means/media of communications, now available or later developed may be used. Each computer device 114, 116, 118, 120 and 122, which may comprise a computer 400 described in more detail below with respect to FIG. 4, may include a central processor that controls the overall operation of the computer and a system bus that connects the central processor to one or more conventional components, such as a memory, data storage, network card or modem. Each computer device 114, 116, 118, 120 and 122 may also include a variety of interface units and drives for reading and writing data or files and communicating with other computer devices and with the exchange computer system 100. Depending on the type of computer device 114, 116, 118, 120 and 122, a user can interact with the computer with a keyboard, pointing device, touch interface, microphone, pen device or other input device now available or later developed.

An exemplary computer device 114 is shown directly connected to exchange computer system 100, such as via a T1 line, a common local area network (LAN) or other wired and/or wireless medium for connecting computer devices. The exemplary computer device 114 is further shown connected to a radio 132. The user of radio 132, which may include a cellular telephone, smart phone, or other wireless proprietary and/or non-proprietary device, may be a market participant, e.g. trader, or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known.

As was described above, the users, i.e. market participants, of the exchange computer system 100 may include one or more market makers 130 which may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

As will be described, the disclosed embodiments may be implemented as part of the Risk Management Module 134 and/or Match Engine Module 106 as will be describe with reference to FIGS. 2 and 7. However, it will be appreciated that the disclosed mechanisms may be implemented at any logical and/or physical point(s), or combinations thereof, at which the relevant information/data may be monitored or is otherwise accessible or measurable, including one or more gateway devices, modems, the computers or terminals of one or more market participants, etc.

FIG. 2 depicts a block diagram of a system 200, which may be referred to as “Velocity Logic,” for mitigating effects of change in a market for a product, such as a financial instrument, which in an exemplary implementation, is implemented as part of the risk management module 134 and/or Match Engine Module 106 of the exchange computer system 100 described above. The financial instrument may be financial derivative product including futures contracts, options on futures contracts, futures contracts that are functions of or related to other futures contracts, swaps, swaptions, or other financial instruments that have their price related to or derived from an underlying product, security, commodity, equity, index, or interest rate product. In one embodiment, the orders are for options contracts that belong to a common option class. Orders may also be for baskets, quadrants, other combinations of financial instruments, etc. The option contracts may have a plurality of strike prices and/or comprise put and call contracts.

FIG. 2 shows a system 200 for mitigating an effect of a change in a market, such as a precipitous or otherwise extreme price change or other market move, either up or down, in short amount of time, for a product traded on an exchange, such as a financial instrument, e.g. futures contracts, options contracts, etc. The system 200 includes a processor 202 and a memory 204 coupled therewith which may be implemented as a processor 402 and memory 404 as described below with respect to FIG. 4. The system 200 further includes first logic 206 stored in the memory 204 and executable by the processor 202 to cause the processor 202 to monitor the market for the product. In one embodiment, the system 200 is coupled with the order books module 110 described above and monitors the relevant parameters of the order book maintained for the product. It will be appreciated that the system 200 may be coupled with other modules of the exchange computer system 100 so as to have access to the relevant parameters as described herein and initiate the requisite actions as further described. The disclosed embodiments may be implemented separately for each market/order book to be monitored, such as a separate process or thread, or may be implemented as a single system for all markets/order books to be monitored thereby. In one embodiment, data 218 representative of each time interval/window/elapse of the duration of time, e.g. each time slice, 220 may be stored in the memory 204 or elsewhere.

The system 200 further includes second logic 208 stored in the memory 204 and executable by the processor 202 to cause the processor 202 to identify, e.g. sample, a comparison value of the product, e.g. a value during each elapse of a duration of time which will be compared with prior values as described herein, such as bid or ask price of an incoming order (“aggressor”) or a trade price thereof if matched to a resting order, and at least one comparative value 222 of the product, which may be stored, such as in the memory 204, for example in association with the data representative of the time window 220, for later comparison with future identified comparison values upon each elapse of the duration of time, e.g. each interval iₙ as shown in FIG. 6, and determining each previously identified comparative value identified within a threshold time thereof. As described above, during each elapse of the time, each comparison value may further be compared with comparative values comprising the preceding comparison values, or a derivation thereof, determined during the elapse of time. As described herein, the comparative value may be derived from the same or a different parameter from the comparison value and more than one comparative value may be determined, such as a minimum and maximum thereof. Upon initiation of monitoring, such as when the market opens or re-opens or trading otherwise commences or after a sufficient period of inactivity (such as within the threshold time), the initial comparison and comparative values may be initialized to configured values or otherwise defined according to rules such as being based on the state of the market at the close of the prior trading period, e.g. based on an indicative opening price.

In one embodiment for use in markets for which outright orders (orders actually placed by a trader) as well as implied orders (orders generated by the Exchange based on outright orders placed in other markets, e.g. spread orders), may be received, only aggressor orders, i.e. outright orders, may be included in the derivation of the comparative values and further utilized as comparison values. In this embodiment, received implied orders may be ignored by the system 200.

In one embodiment, the value of the product comprises, for example, a bid price of the product, an ask price of the product, a last traded price of the product, a last traded quantity of the product, a volatility of the product, or other market attribute value, or combination thereof. It will be appreciated that the value of the product may be determined according to other metrics of product value.

In one embodiment, the second logic 208 is further executable by the processor 202 to cause the processor 202 to determine the comparison value of the product as a value of each order to trade the product received during the elapse of the duration of time, e.g. the bid price, the ask price or trade price. In one embodiment, the comparative value is derived from the same parameter as the comparison value. It will be appreciated that fewer than all orders to trade may be compared, and that this sampling frequency may be configurable.

Alternatively, the second logic 208 may be further executable by the processor 202 to cause the processor 202 to determine the at least one comparative value of the product as a minimum value of the product over the duration of time, e.g. the interval iₙ which just elapsed, maximum value of the product over the duration of time, an average of the value of the product over the duration of time, or combinations thereof. In one embodiment, the comparative value(s) may be computed as a weighted average wherein more recent values are favored over older vales.

The threshold time, which in one implementation may be the Time Slice Count, defines how far back the system 200 will look, referred to above as a “window” or number of active slices or intervals, i.e. how many intervals will be compared, and may be specified in seconds, milliseconds and/or as a multiple of the duration of time, i.e. interval in, e.g. Time Slice Count. It will be appreciated that different threshold times, e.g. asymmetric time windows, may be specified for positive market changes and negative market changes, such as where the rate of negative movement, e.g. a dip, is determined to be more critical than the rate of positive market movement, e.g. a spike. It will be appreciated that the threshold time may be set so as not to be less than a minimum amount of time required for a market participant to react to a change in the market, e.g. receive and assimilate market data indicative of the change and submit an order responsive thereto. In other words, the threshold time should be set so as to allow the market participants a chance to respond and correct an extreme market change before the system 200 reacts thereto as described.

The system 200 further includes third logic 210 stored in the memory 204 and executable by the processor 202 to cause the processor 202 to determine a difference between the identified comparison value, e.g. sample, and each of the determined previously identified comparative values. The current sample/comparison value is compared only with previously identified comparative values that are within the defined time window, i.e. within the threshold time of the current time.

The system 200 further includes fourth logic 212 stored in the memory 204 and executable by the processor 202 to cause the processor 202 to determine if any of the determined differences deviate, either higher or lower, from a threshold value. As described above the threshold value defines the magnitude of movement, either up (positive) or down (negative), which would be tolerated, e.g. considered normal market behavior. The threshold value may be specified in terms compatible with the values being monitored and compared, such as price ticks, points or other metrics. For example, the threshold value may be 10 ticks. If the comparison value differs from one of the relevant prior comparative values but more than 10 ticks, either more than 10 ticks above or more than 10 ticks below, a deviation is determined. It will be appreciated that the threshold values may be asymmetric, i.e. a threshold value may be specified for positive market changes and a different threshold value may be specified for negative market changes, such as where market dips are considered more critical than market spikes. In one embodiment, the threshold value(s) may be dynamic and may vary over time, such as from interval to interval, such as based on market activity, e.g. volume or volatility.

It will be appreciated that the comparative values and/or the threshold values may be configured such that a comparison subsequent to the elapse of the duration of time may not cause a result different from that had the comparison been performed just prior to the elapse of the duration of time. For example, it may be desirable to configure the comparative and/or threshold values such that an incoming order received after the end of an interval would cause the same result as if that order had been received just prior to the end of that interval.

The system 200 further includes fifth logic 214 stored in the memory 204 and executable by the processor 202 to cause the processor 202 to perform an action, when any of the determined differences deviate the threshold value. That is, if the market moved too far, up or down, too fast, e.g. the slope or gradient of the movement (or angular or other measure thereof) vs. the time over which the movement is measured is too steep, positive or negative, it is determined that a qualifying event has occurred, referred to as a “Velocity Logic Event,” and one or more actions may be taken or caused to be taken.

In one embodiment, the action may include placement of the market for the product in a reserved state, as was described above, such as for a limited time period which may be configurable and may be a static or dynamic value and may vary among markets. In one embodiment, if during the reserved state additional conditions, such as based on whether the market is recovering to a normal operating state or not as the reserved state is nearing an end, are met, the time limit for staying in reserved state may be extended. Alternatively, or in addition thereto, the action may include transmission of an alert to an operator of the exchange, such as the GCC of the CME, a trader of the product, or a combination thereof. Alerts may be sent as market data. Where the market is placed in a reserved state, the alert may further advise the recipient of this state. A subsequent message may then be sent when the market is taken out of the reserved state or if the reserved state is extended. Alternatively, or in addition thereto, the action may include permanent or temporary enablement of trading opportunities for the product in a different market. For example, implied markets for which the current product may be a leg, etc. may be enabled to create additional matching opportunities, i.e. additional liquidity. Alternatively, or in addition thereto, the action may include permanent or temporary prevention of trading of the product at a price outside of a price limit, i.e. a ceiling or floor. If the detected extreme movement is downward, the limit may set as a limit below which trading is not allowed, e.g. a floor. Alternatively, if the detected extreme movement of the market is upward, the limit may be set as a limit above which trading is not allowed, e.g. a ceiling. In one embodiment, if orders to trade are subsequently received substantially close to, or at, or otherwise within a threshold of, the limit, the limit may be periodically raised (or lowered), such as after a defined delay period, to gradually allow a market, intent on reaching a particular price, to eventually reach the price in a controlled manner, e.g. the market is slowed down.

Alternatively, or in addition thereto, the action may include modifying the matching/allocation algorithm used to allocate incoming orders to resting orders. For example, if the current matching algorithm is First-In-First-Out (“FIFO”), also referred to as Price-Time, the algorithm may be changed to Pro-Rata. Other algorithms which may be used include Price Explicit Time, Order Level Pro Rata, Order Level Priority Pro Rata, Preference Price Explicit Time, Preference Order Level Pro Rata, Preference Order Level Priority Pro Rata, Threshold Pro-Rata, Priority Threshold Pro-Rata, Preference Threshold Pro-Rata, Priority Preference Threshold Pro-Rata, Split Price-Time Pro-Rata. See U.S. patent application Ser. No. 13/534,399 entitled “MULTIPLE TRADE MATCHING ALGORITHMS” herein incorporated by reference.

In one embodiment, the system 200 may further include sixth logic 216 stored in the memory 204 and executable by the processor 202 to cause the processor 202 to receive the duration of time, the threshold time and the threshold value, or other parameters which control the operation of the disclosed embodiments, such as from the operator of the exchange computer system, e.g. the GCC of CME. These configurable parameters include: which markets to be monitored if not all markets, such as where performance constraints limit deployment or where it may be determined that some markets are not susceptible to the problems described herein and therefore need not be monitored; the comparison value (which may be referred to below as the VL Price or Trade Price), such as which parameter of the market should be used during the operation of the system 200 and/or the initial value thereof, which may be specified as a dollar amount, tick value or other metric; the comparative values (which may be referred to below as the VL Ref Low and VL Ref High values), such as which parameter(s) of the market should be used during the operation of the system 200 and/or the initial value(s) thereof, which may be specified as a dollar amount, tick value or other metric; the duration of time or interval (which may be referred to below as the Time Slice Length) and may be specified as a number of seconds or milliseconds; the threshold time or window (which may be referred to below as the Time Slice Count or number of intervals or alternatively as the Time Slice Count*Time Slice Length) and may be specified as a number of intervals or a length of time, in seconds or milliseconds for example, and may be a multiple of the duration of time/interval/Time Slice Length; the threshold value (which may be referred to below as the VL Value); the action(s) to be taken; the time limit for keeping a market in a reserved state; or other parameters. It will be appreciated that any or all of these parameters may be statically defined for application to all markets, may vary from market to market and/or may be dynamically configured/re-configured during operation, either automatically responsive to market conditions or manually, e.g. by the operator of the exchange computer system 100.

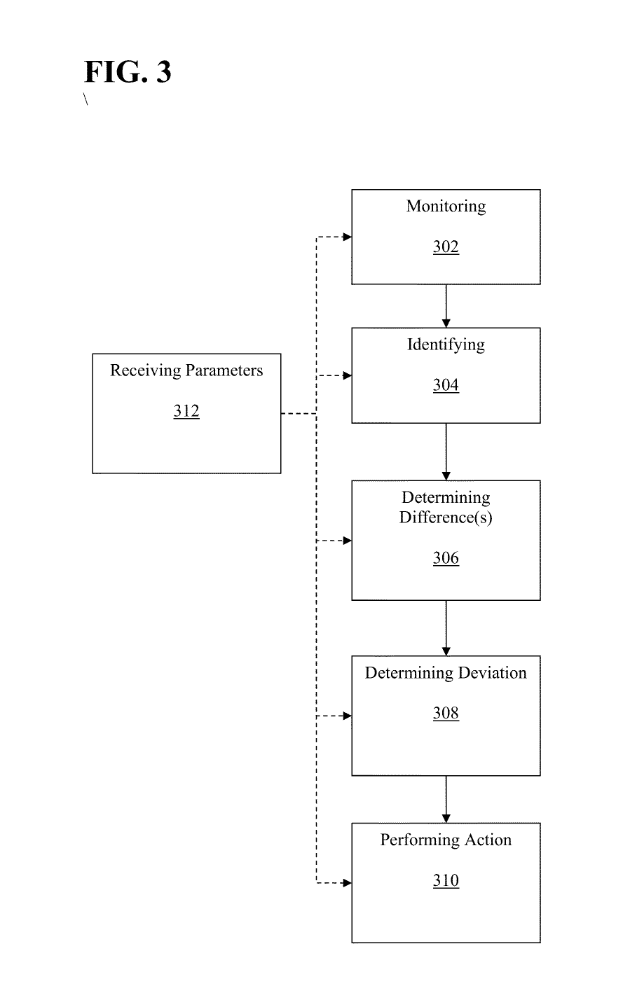

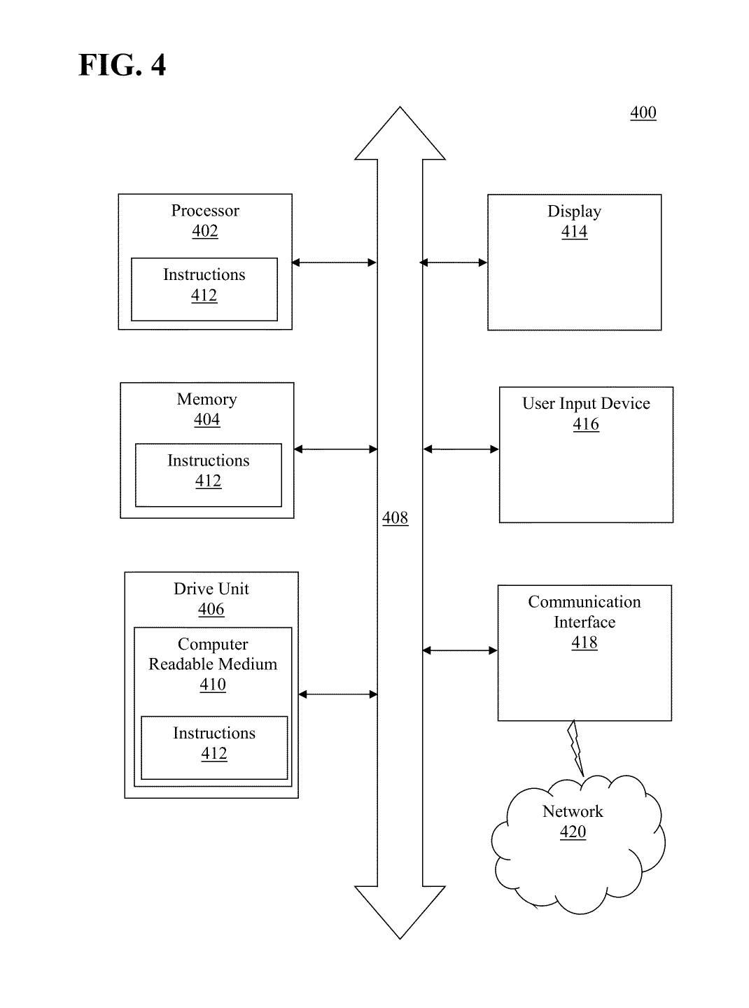

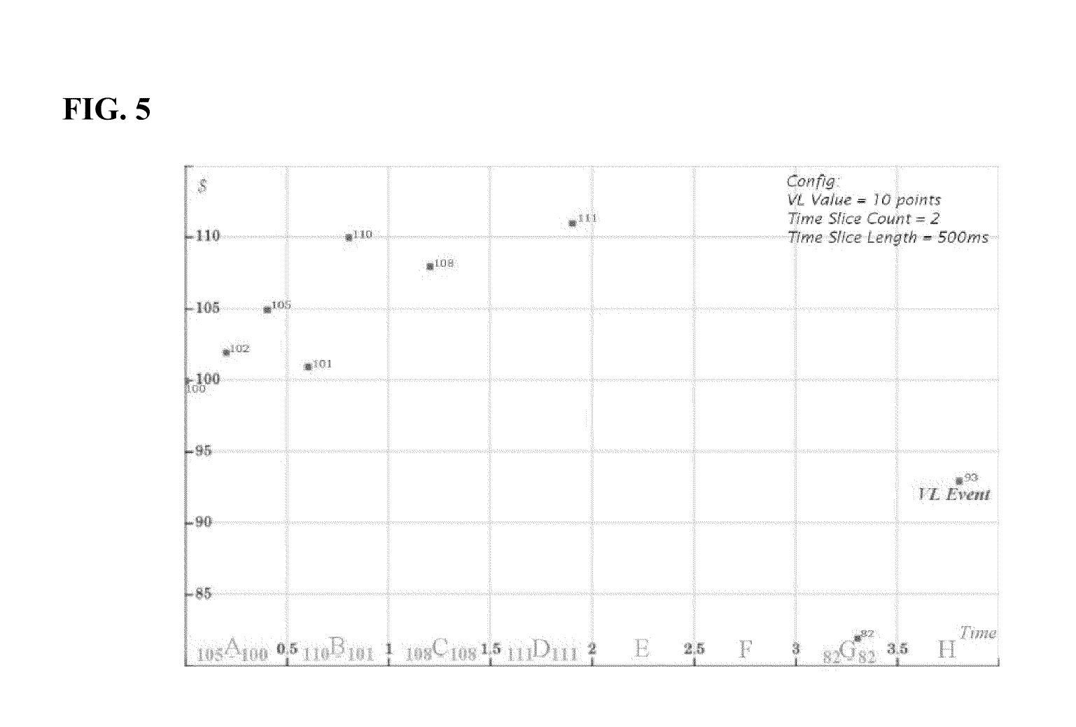

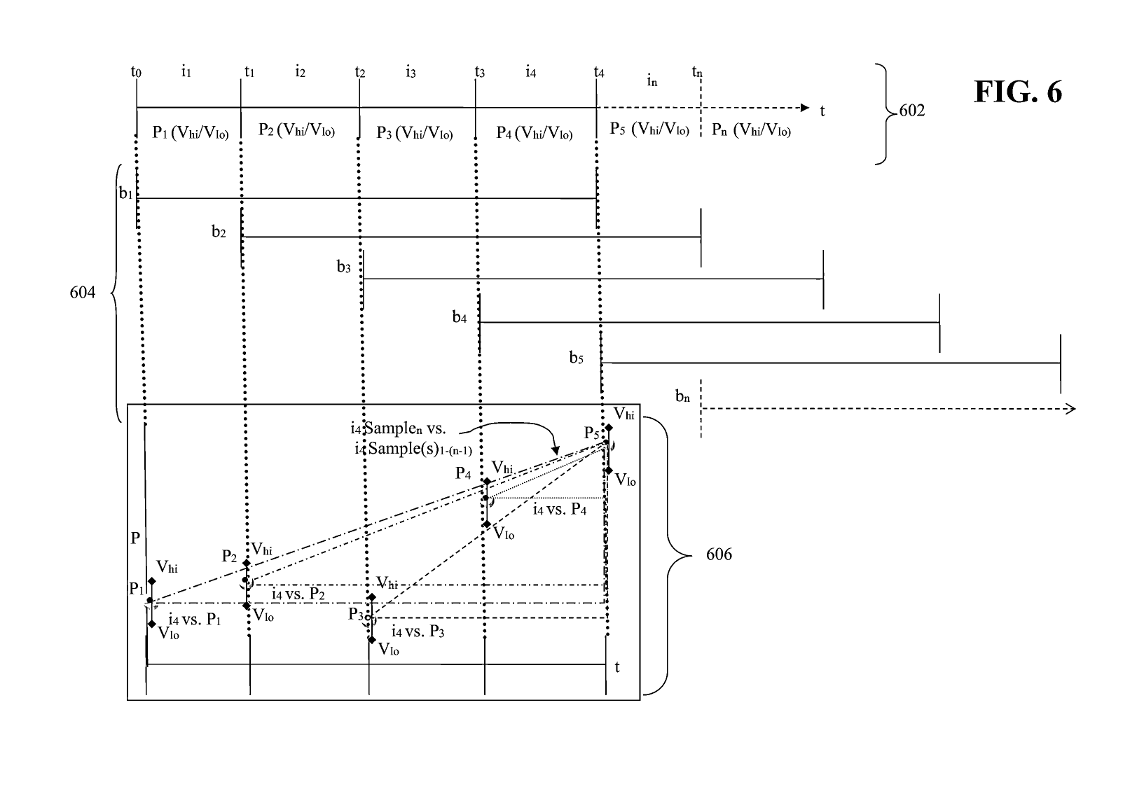

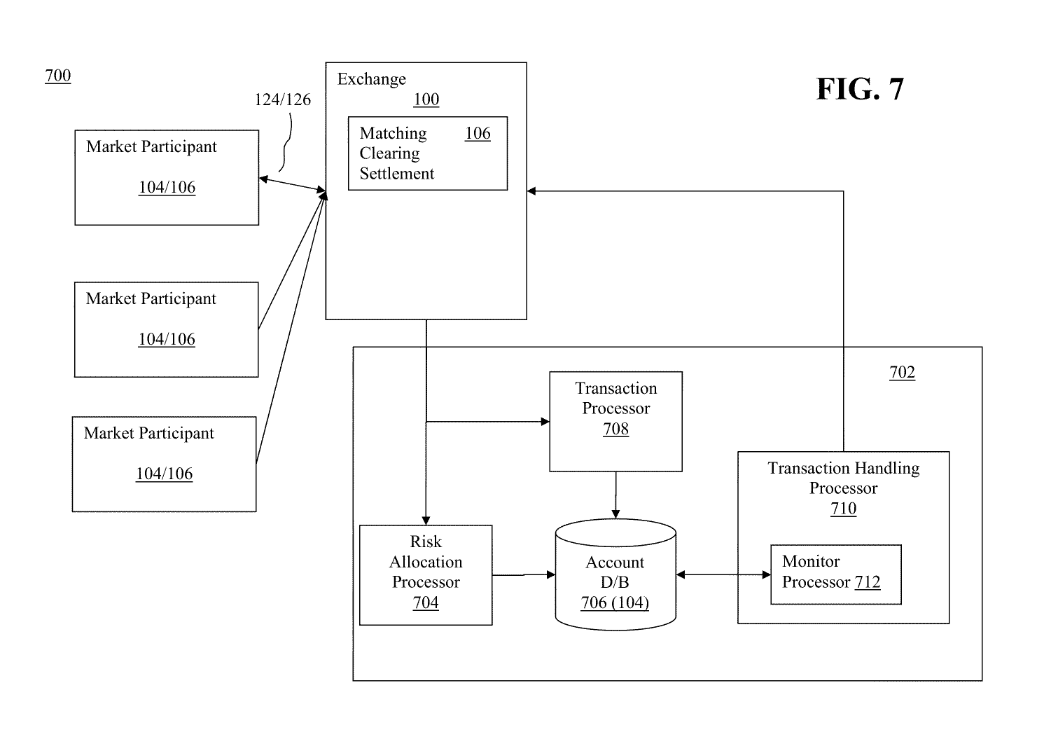

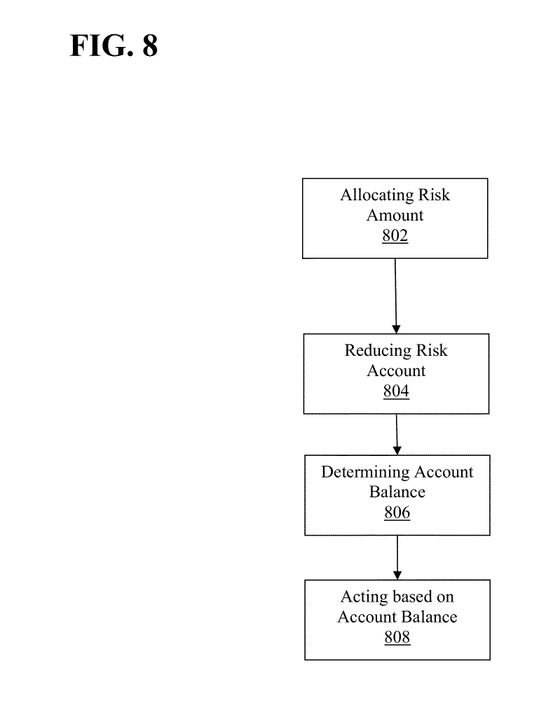

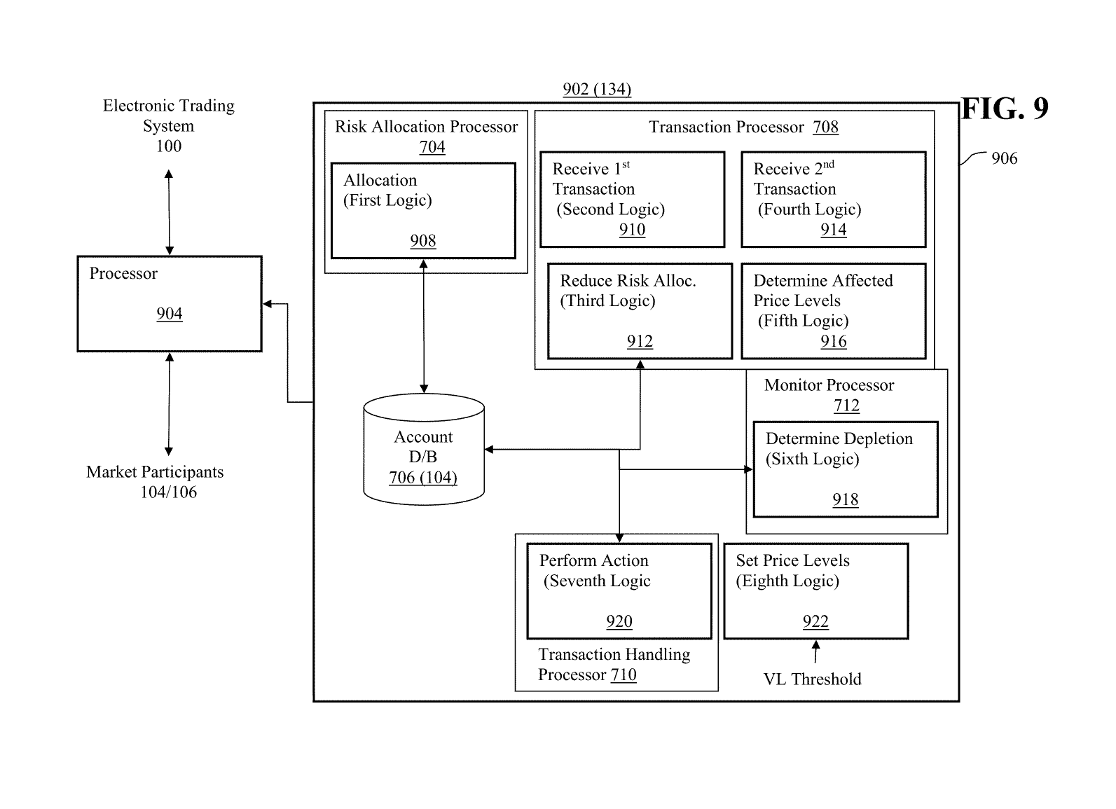

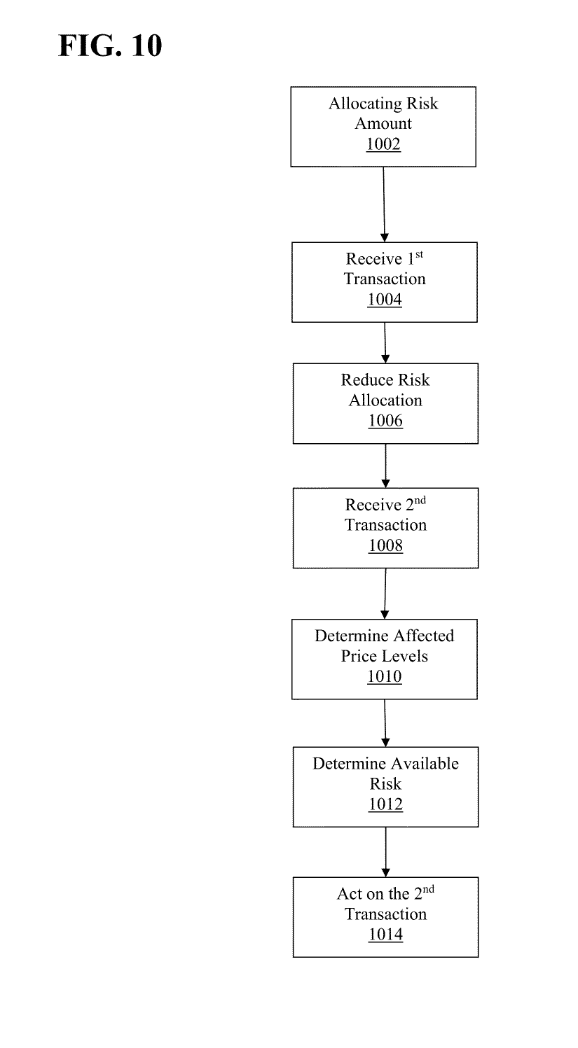

FIG. 3 depicts a flow chart showing operation of the system 200 of FIG. 2. In particular FIG. 3 shows a computer implemented method for mitigating an effect of a change in a market for a product traded on an exchange. The operation includes: monitoring, by a processor 202, the market for the product (Block 302); identifying, by the processor 202, a comparison value of the product during elapse of a period of time and at least one comparative value of the product preceding the comparison value and/or upon each elapse of the duration of time and determining each previously identified comparative value identified within a threshold time thereof (Block 304); determining, by the processor 202, a difference between the identified comparison value and each of the determined previously identified comparative values (Block 306); determining, by the processor 202, if any of the determined differences deviate from a threshold value (Block 308); and performing, by the processor 202, an action, when any of the determined differences deviate from the threshold value (Block 310.

In one embodiment, the value of the product may include a bid price of the product, an ask price of the product, a last traded price of the product, a last traded quantity of the product, a volatility of the product, or other market attribute value or combination thereof.

In one embodiment, the identifying further includes determining the comparison value of the product as a value of each order to trade the product received during the elapse of the duration of time. It will be appreciated that fewer than all orders to trade may be compared, and that this sampling frequency may be configurable.

In one embodiment, the identifying further includes determining the at least one comparative value of the product as a minimum value of the product over the duration of time, maximum value of the product over the duration of time, an average of the value of the product over the duration of time, or combinations thereof.

In one embodiment, the threshold time may be specified as a multiple of the duration of time, e.g. time slice length multiplied by time slice count.

In one embodiment, the identifying further includes storing the identified comparative value(s) in a memory.

In one embodiment, the action may include placing the market for the product in a reserved state, sending an alert to an operator of the exchange, a trader of the product, or a combination thereof, enabling trading opportunities for the product in a different market, preventing trading of the product at a price outside of a price limit, or combinations thereof.

The operation of the system 200 may further include receiving, by the processor, the duration of time, the threshold time and the threshold value, or other configurable parameters, prior to initiating operation of the system 200 or during the operation thereof, as was descried above (Block 312).

An example of the operation of the system 200 is provided below. In the examples which follow, the following definitions may be used:
Agressing/Aggressor order—an order that the engine can attempt to match against the book;
Velocity Logic (“VL”) Event—a condition detected by the system 200 wherein an incoming Velocity Logic eligible Market Event violates the Floor or Ceiling of a particular Time Slice/interval;
VL Value (threshold value)—the GCC configured Value that is added or subtracted to determine the VL Ref High or VL Ref Low (defined below). This value may be specified as a number of points only, as opposed to ticks. This value may acts as a +/− width;
Time Slice—a configurable period of time over which market attributes are tracked and compared, also referred to as an interval.
Time Slice Count—the GCC configured number of Time Slices or intervals the system 200 should use to detect VL events;
Time Slice Length (duration of time)—the GCC configured length of time each Time Slice/interval. May be specified as a number of milliseconds or other time increment;
VL Detection Duration=Derived as Time Slice Count*Time Slice Length. In one embodiment this value is derived from the Time Slice Count and Time Slice Length values. However it will be appreciated that this value may instead be specified along with one of the Time Slice Count or Time Slice Length with the unspecified value being derived.
VL Prices—in the examples which follow, in the Open or non-reserved state, the system 200 may use these prices to detect Velocity Logic events:
   Better Bids/Offers;
   Trades;
   Implied Better Bids/Offers;
   Curve Banding (if on);
      When using the CurveBanding price, if GCC has configured an Offset, the Engine will apply the offset to the CurveBanding price and then utilize this price for Velocity Logic; or
      Actionable, tradeable or otherwise executable price.
VL Ref High (Comparative Value)—the highest VL Price in a given Time Slice
VL Ref Low (Comparative Value)—the lowest VL Price in a given Time Slice
Floor—derived as VL Ref High − VL Value
Ceiling—derived as VL Ref Low + VL Value
VL Range=the range that VL detectable market activity can be within, derived as the Ceiling—Floor.

In one embodiment, the system 200 may be described using Overlapping Time Slices as follows:

Velocity Logic Order of Operations:
1. Bands are checked first
2. Velocity is checked after bands
3. Stop Logic is checked only if the order is a Stop order and after #1 and #2

Velocity Logic Operates as Follows:
1. a. Save the Hi & Lo VL Reference Value of the last Time Slice
   b. Cleanup old VL Ref Vals
   c. Compare VL Reference Values:
      i. How to compare:
         1. Trade Price is less than Lo VL Reference Value + VL Value
         2. Trade Price is greater than Hi VL Reference Value − VL Value
      ii. What to Compare:
         1. Current Time Slice
         2. Prior Time Slice
      iii. Result
         1. All comparisons against Current and Prior Time Slices must be True
         2. If one comparison is false, VL Event detected.
   d. Accumulate/Track VL Ref Vals of the Current Time Slice

In exemplary operation wherein a GCC User wishes to detect rapid price moves within a specified time, so that the system 200 can identify Velocity Logic events accurately and efficiently, the system 200 may operate as follows (Refer to FIG. 5 for a graph of the values described below):

Configurations:
VL Value=10
Time Slice Count=2
Time Slice Length=500 ms
VL Detection Duration=1000 ms

Step-by-Step:
1. Opening trade at 100 in TS:A (Time Slice A)
   a. VL Reference Value of Current TS: Hi=100, Lo=100
2. Trade at 102 in TS:A
   a. Save VL RefVal of Last Time Slice—n/a
   b. Cleanup old VL RefVals—n/a
   c. Compare
      i. Current Time Slice=(100−10) to (100+10), range is 90 to 110, trade of 102 passes
      ii. Prior Time Slices=n/a
   d. Accumlulate/Track VL RefVal of Current Time Slice: Hi=102, Lo=100
3. Trade at 105 in TS:A
   a. Save VL RefVal of Last Time Slice—na
   b. Cleanup old VL RefVals—n/a
   c. Compare
      i. Current Time Slice=(102−10) to (100+10), range is 92 to 110, trade of 105 passes
      ii. Prior Time Slices=n/a
   d. Accumulate/Track VL RefVal of Current Time Slice: Hi=105, Lo=100
4. Trade at 101 in TS:B
   a. Save VL RefVal of Last Time Slice—TS:A Hi=105, Lo=100
   b. Cleanup old VL RefVals—n/a
   c. Compare
      i. Current Time Slice=n/a
      ii. Prior Time Slices=(105−10) to (100+10), range is 95 to 110, trade of 101 passes
   d. Accumulate/Track VL RefVal of Current Time Slice: Hi=101, Lo=101
5. Trade at 110 in TS:B
   a. Save VL RefVal of Last Time Slice—n/a
   b. Cleanup old VL RefVals—n/a
   c. Compare
      i. Current Time Slice=(101−10) to (101+10), range is 91 to 111, trade of 110 passes
      ii. Prior Time Slices=(105−10) to (100+10), range is 95 to 110, trade of 110 passes
   d. Accumulate/Track VL RefVal of Current Time Slice: Hi=110, Lo=101
6. Trade at 108 in TS:C
   a. Save VL RefVal of Last Time Slice=TS:B Hi=110, Lo=101
   b. Cleanup old VL RefVals—n/a
   c. Compare
      i. Current Time Slice=n/a
      ii. Prior Time Slices
         1. TS:B=(110−10) to (101+10), range is 100 to 111, trade of 108 passes
         2. TS:A=(105−10) to (100+10), range is 95 to 110, trade of 108 passes
   d. Accumulate/Track VL RefVal of Current Time Slice: Hi=108, Lo=108
7. Trade at 111 in TS: D
   a. Save VL RefVal of Last Time of Current Time Slice: Hi=108, Lo=108
   b. Cleanup old VL RefVals—clear TS:A values out
   c. Compare
      i. Current Time Slice=n/a
      ii. Prior Time Slices
         1. TS:C=(108−10) to (108+10), range is 98 to 118, trade of 111 passes
         2. TS:B=(110−10) to (101+10), range is 100 to 111, trade of 111 passes
   d. Accumulate/Track VL RefVal of Current Time Slice: Hi=111, Lo=111
8. Trade at 82 in TS:G
   a. Save VL RefVal of Last Time Slice—TS: D Hi=111, Lo=111
   b. Cleanup old VL RefVals—clear all values from TS: D and prior
   c. Compare
      i. Current Time Slice=n/a
      ii. Prior Time Slices=n/a, trade of 82 passes
   d. Accumulate/Track VL RefVal of Current Time Slice: Hi=82, Lo=82
9. Trade at 93 in TS:H
   a. Save VL RefVal of Last Time Slice—TS:G Hi=82, Lo=82
   b. Cleanup old VL RefVals—n/a
   c. Compare
      i. Current Time Slice=n/a
      ii. Prior Time Slices=(82−10) to (82+10), range is 72 to 92, trade of 93 fails and is not allowed, VL Event occurs

Additional examples of operation of the system 200

Given—
Price Banding is off
a VL Value of 10
a Time Slice Length of 10000 ms (10 seconds) a Time Slice Count of 0
a Trade of 100

When—
a Trade of 89 occurs (within the same Time Slice as the Trade of 100)

Then—
The system 200 should detect a VL event, which results in a Monitor Message stating “Warning: CLH3 Velocity Logic Event detected. Trade Price [89], VL Ref Price [100].”

### Example 2

Wherein the system 200 compares current trades against the current time slice's only trade, so that VL events are detected

Given—
Price Banding is off
a VL Value of 10
a Time Slice Length of 10000 ms (10 seconds) a Time Slice Count of 0
a Trade of 100

When—
a Trade of 111 occurs (within the same Time Slice as the Trade of 100)

Then—
The system 200 should detect a VL event, which results in a Monitor Message stating “Warning: CLH3 Velocity Logic Event detected. Trade Price [111], VL Ref Price [100].”

### Example 3

Wherein only VL Prices in the current Time Slice to trip VL, so that old VL Prices do not cause a VL event:

Given—
Price Banding is off
a VL Value of 10
a Time Slice Length of 10000 ms (10 Seconds) a Time Slice Count of 0
a Trade of 100
wait 11 seconds

When—
a Trade of 89 occurs

Then—
the trade should be allowed and no FAS Monitor Message is displayed

### Example 4

Given—
Price Banding is off
a VL Value of 10
a Time Slice Length of 10000 ms (10 Seconds) a Time Slice Count of 0
a Trade of 100
wait 11 seconds

When—
a Trade of 111 occurs

Then—
the trade should be allowed and no Monitor Message is displayed

In one embodiment, the system 200 may not utilize settlement prices as the comparison/comparative values. In one embodiment, the system 200 may compare current trades against the current Time Slice's Best Bid or Best Offer, so that VL events are detected. In one embodiment, the VL Value may be added/subtracted in full when calculating the VL Range, so that the VL Value acts as a width. In one embodiment, the system 200 may compare prices to VL Reference Values inclusive of the VL Range, so that Prices that occur that are equal to the VL Range do not trigger a VL event. In one embodiment, the system 200 may be enabled or disabled by the operator of the electronic trading system 100 as to all markets or particular markets.

In one embodiment, the system 200 uses a VL Reference Value at the beginning of a Time Slice, so that Velocity Logic can be consistent with current market conditions. This may be tested as follows:

Test 1:
VL Value=10, TSC=2, TSL=500 ms
Trade 1@100
Trade 1@91
Wait 500 ms
Trade 1@112, VL Event triggered, VL Range violated should be 90->111

In one embodiment, the VL Reference Values may be cleaned up over time, so that they are not part of Velocity Logic beyond the configured number of Time Slices. This may be tested as follows:

Test 1:
VL Value=10, TSC=2, TSL=500 ms
Trade 1@100
Trade 1@91
Wait 1500 ms
Trade 1@112, trade is allowed

In one embodiment, the system 200 compares Prices to VL Reference Values within the Current Time Slice and the Prior # of Configured Time Slices, so that there are no gaps in VL detection. This may be tested as follows:

Test 1:
VL Value=10, TSC=2, TSL=500 ms
Trade 1@100
Trade 1@91
Wait 500 ms
Trade 1@95, within VL Range of TS:1 90->111, trade passes.
Hi/Lo of CTS is 95/95
Trade 1@112, VL Event triggered since VL Range of CTS violated (85->105)

In one embodiment, the system 200 accumulates prices toward the future, so that prices that occur on the time slice boundary count for the Current Time Slice. This may be tested as follows:

Test 1:
VL Value=10, TSC=2, TSL=500 ms
TOP Trade 1@100, Hi/Lo of CTS is 100/100
Trade 1@112, VL Event triggered since VL Range of CTS is 90->110

In one embodiment, the VL Value may be added/subtracted in full when calculating the VL Range, so that the VL Value acts as a width. This may be tested as follows:

Test 1:
VL Value=10, IXM Tick=0.3333
Hi/Lo of CTS is 100/100
Trade 1@112, VL Event triggered since VL Range of CTS is 90->110

In one embodiment, the system 200 compares Prices to VL Reference Values inclusive of the VL Range, so that the Prices that occur that are equal to the VL Range do not trigger a VL event. This may be tested as follows:

Test 1:
VL Value=10, TSC=2, TSL=500 ms
Trade 1@100, Hi/Lo of CTS is 100/100, VL Range is 90->110
Trade 1@91, Hi/Lo of CTS is 100/91, VL Range is 90->111
Trade 1@111, trade passes

In one embodiment, the system 200 uses Time Slice Length to determine the duration of each Time Slice. This may be tested as follows:
Test 1:
VL Value=10, TSC=2, TSL=500 ms
Trade 1@100
Trade 1@91, Hi/Lo of CTS is 100/91, VL Range is 90->111
Wait 1000 ms
Trade 1@111, Hi/Lo of CTS is 111/111, VL Range is 91->121
Trade 1@112, VL Event triggered because 112 violates VL Range of first Time Slice, 90->111

In one embodiment, the system 200 uses Time Slice Count to determine how VL RefVals are cleaned up over time. In one embodiment, the system 200 derives a VL Detection Duration from the configuration, so that the length of time that the market will be safeguarded may be known. In one embodiment, the

VL Reference Value may be specified in points only, rather than ticks, so that exchange operator, e.g. GCC, can configure markets consistently. In one embodiment, the system 200 uses a minimum Time Slice Count of 0, so that the Engine can track the market accurately during a specified time. In one embodiment, the VL Reference Values may age only over time, so that they remain in effect through changes in state. In one embodiment, the system 200 applies to Spread products, so that these markets can also be safeguarded. In one embodiment, the system 200 may check Trade Prices, so that Velocity Logic can detect events accurately.

In one embodiment, the system 200 checks the Arriving Order Limit Prices, so that the system can detect events accurately. For example:

VL Value=10, VL Ref Value Hi=100 Lo=100, VL Range is 90 to 110

Test 1
Ask 1@109.0
Bid 1@111.0
   w/o VL, Trade occurs 1@109.00
   w/VL LMT price check, VL Event occurs

Test 2
Ask 1@109.0
Bid 2@111.0
   w/o VL, Trade occurs 1@109.00, 1@111.0 rests, C.Last 111.0
   w/VL LMT price check, VL Event occurs

Test 3
Ask 1@109
Ask 1@111
Bid 2@111
   w/o VL, Trade 1@109, Trade 1@111
   w/VL LMT price check, VL Event occurs

Test 4
Bid 1@112
   w/o VL, 1@112 rests
   w/VL LMT price check, VL Event occurs

In one embodiment, the system 200 checks MKT-Protect and STP-Protect prices, so that the system 200 can detect events accurately.

In one embodiment, the system 200 is configurable so that the system 200 can be adapted to meet the needs of different markets.
VL Warning Value—the price range the market is allowed to move before an alert is generated. Configuration is needed to enable/disable and specify the numeric value.
Iteration—similar to Stop Logic (“SPL”); the number of iterations a Velocity Logic action should occur before the market is allowed to reopen.
Reserve Time—the length of time a Velocity Logic Iteration will last. Config is needed for Regular and Extended hours.
Reserve Group—when enabled, the ability to have a Velocity Logic action apply to the instrument and its group.

In one embodiment, the system 200 is applicable to a Group or an IXM, so that maximum flexibility in adapting the system 200 to a Market's specific needs is provided. It will be appreciated that some markets are heavily dependent on lead-month trading activity (e.g. Crude Oil), while others have activity across the entire curve (e.g. Euro-Dollar). The operator of the exchange computer system 100 should be able to configure the system 200 such that lead-months are handled differently than the rest of a group.

In one embodiment, the system 200 may include a user interface (not shown) coupled with the processor 202 such as may be implemented via the display 414 and user input device 416 which allows the Configurations to be viewed so that the correct values can be verified for each market, new Configurations to be created, entirely or based on Stop Logic Configuration values, modify configurations prior to or during operation of the system 200, delete configurations, or combinations thereof.

In one embodiment, Velocity Logic Events may extend when the time has elapsed and the market is outside a value from the starting price, so that a market does not reopen very far away from the Reference Value. In one embodiment, a Velocity Logic Event may end when a time has elapsed, so that the Market can resume normal trading. In one embodiment, a Velocity Logic Event may end after a configured number of extensions, so that the Market can resume normal trading.

As can be seen, the above disclosed embodiments provide a mechanism which is able to react to a rapidly changing market, one which may change faster than the market participants, or entities responsible for the activities thereof, e.g. risk managers, can respond, e.g. to modify or cancel previously placed orders before those orders may be disadvantageously executed. In particular, for example, the price movement threshold for the above described mechanism effectively defines the extent to which open/resting orders within a given market could be executed before the systems takes action, such as by placing the market in a reserved state. Accordingly, by restricting or otherwise managing the extent of exposure of any particular market participant within the price movement threshold of the market protection system described above, a mechanism for controlling risk of loss, referred to as a “credit control” mechanism, may be implemented which acts to reduce or otherwise manage a market participant's ability to concentrate their exposure, or risk of loss, within a range of price levels that could be executed upon before the market participant has an opportunity to react to rapid market movement. Such a mechanism, once the market protection system had activated, e.g. by placing the market in reserve, may permit the market participant the opportunity to modify or cancel unexecuted orders to mitigate potential losses. Furthermore, by providing an added/more granular layer of credit control, a market participant may be prevented from submitting orders that have a higher probability of later being canceled which improves the overall health of market by ensuring that the overall market's, i.e. all of the other market participants, view of available liquidity, i.e. available opportunities to trade, is accurate and actionable. A further benefit of the disclosed embodiments is the prevention of trading errors such as where a trader accidentally submits multiple orders, e.g. by accidentally pressing their submit button multiple times, or submits an order for an incorrect quantity, such as a quantity much larger than intended, e.g. by mistakenly adding too many zeroes to their quantity entry or mis-entering a decimal point.

In the context of foreign currency trading, the trading system 100 may provide mechanisms by which market participants may request quotes from other market participants to determine prices at which they are willing trade. One such exemplary system is described in U.S. patent application Ser. No. 13/324,786, filed on Dec. 13, 2011, herein incorporated by reference, which discloses a mechanism for allowing one market participant to make a directed request for quote (“DRFQ”) from another market participant which may then respond with an actionable quote. Acceptance of an actionable quote binds the responding market participant to the transaction. As each actionable quote represents a transaction, which may open for given period of time, to which the responding market participant may be bound, there is a certain amount of risk associated therewith until such time as the DRFQ response terminates, i.e. is accepted or expires. In addition, in an active market, there will be many DRFQ's pending/open at any given time, some for the same products, and a given market participant may have many responses, i.e. actionable quotes “alive” at any given time, in response to many DRFQ's, including DRFQ's for the same products. A time based expiration system, referred to as “time to live” (“TTL”), may assist in mitigating the number of open-ended transactions that are pending at any given time, however, a market participant may still have a significant amount of exposure in the market. For example, in response to several DRFQ's for the same product, a given market participant may issue multiple actionable quotes, intending, upon acceptance of one of those quotes, to terminate the remaining quotes. If, however, more than one of the pending actionable quotes should be accepted before the market maker can act and terminate those they did not wish to have accepted, they will be bound to the associated transactions, potentially incurring more liability than anticipated. Alternatively, or in addition, the Exchange, or other entity, such as a risk manager, which oversees or is otherwise liable for the activities of the exposed market participant, may desire to limit the amount of exposure/risk of the various participating market participants in order to minimize risk of loss, minimize loss exposure, maintain market stability and reliability and/or avoid activities which would be detrimental thereto. Accordingly, mechanisms may be provided to monitor the amount of exposure/risk that a given market participant has at any given time, in one or more markets or all markets, and provide mechanisms to mitigate or otherwise control that exposure. Such mechanisms may include alerting mechanisms and/or transaction management mechanisms such as mechanisms to prevent a market maker from further responding to DRFQ's, and thereby incur additional risk/exposure, reduce the number pending actionable quotes, or combinations thereof. Further, the disclosed embodiments recognize that excessive exposure may be incurred via multiple smaller transactions, a few large transaction or combinations thereof.

Similarly with respect to trading futures contracts, for example, a market participant, e.g. a trader, may place an order to buy or sell at a price/price level at which there are no prior counter orders resting (previously received but unsatisfied) in the market, i.e. on the order book. Such a market participant may be referred to as a “non-aggressor”, “liquidity provider” or “market maker” with respect to such orders. Accordingly, the order will be rested on the order book and its availability advertised to the other market participants to await a suitable counter order (which may be referred to as an “aggressor” order, placed by an “aggressor” market participant), or cancellation/modification by the non-aggressor market participant who placed the order. Furthermore, non-aggressor market participants may submit orders at various price levels within a particular market at which there are no prior counter orders, referred to as “laddering” or “layering” the book, in order to provide liquidity in the market, i.e. create trading opportunities, manage their risk in terms of the magnitude of their spread, or for other reasons. For example, such a non-aggressor market participant may wish to create a scenario where an aggressor market participant who submits counter orders to resting orders at multiple price levels in an effort to capture all of the available quantity, referred to as “sweeping” the book, will incur some measure of penalty, by having some trades execute at higher prices, for taking liquidity from the market. Further, a market participant may submit orders in multiple markets, such as markets for products which are characterized by a correlation there between, such as a correlation between price movement, volatility or other characteristic. Typically, however, a non-aggressor market participant who places multiple orders at different price levels, usually placed away from the best bid/best ask (“inside market”), and/or in different markets, has little or no interest in having all of those orders executed. In practice, once one or more of the resting orders are traded, the market participant will cancel some or all of their remaining orders.

However, while orders are resting, they are subject to potential matching and execution via the normal operation of the market and, as will be appreciated and as was described above, with advent of electronic trading systems and high speed trading architectures the normal operation of the market can, at times, proceed at a rapid pace. If a market participant, or another entity responsible for the activities thereof, such as a risk manager, is unable to timely cancel their orders, they, or another responsible party, may be bound to those transactions and subject to any related losses. Such a situation could occur, for example, when a high frequency trader rapidly submits counter orders against all, or a substantial portion, of a market participant's laddered resting/open orders faster than the market participant, or other responsible party, can respond to cancel them. Accordingly, as with market participants in the foreign exchange markets, market participants in futures and other markets face a similar risk of over exposure.

An exemplary risk management system which addresses risk of over exposure may quantify risk into defined/measurable units, each unit representative of a defined “amount” of risk, measured in dollars, quantity units, e.g. lots, number of contracts, or some other metric such as delta (a ratio comparing the change in the price of the underlying asset to the corresponding change in the price of a derivative), profit/loss, etc. Each market participants may then allocated a certain amount of risk units, either statically and/or dynamically, to be used over a particular period which may be temporally defined, transactionally defined, or a combination thereof. The allocation may be for a particular market, set of markets or all markets. Further, as will be describe below in more detail, risk units may be allocated by price level or subsets thereof, within a market or across markets, e.g. correlated markets. For example, the system may include a centralized risk allocation system such as a risk bank which maintains risk accounts for each market participant, each risk account maintaining one or more risk balances reflecting the amount of risk units available to cover transactions is one or more markets, used or consumed or otherwise unavailable, or a combination thereof. The initial allocation of risk units may be based on multiple factors including credit rating, historical performance, margin account levels, government or other regulation, self, organization or exchange imposed limitations/policies or other factors or combinations thereof. As a market participant issues actionable quotes or otherwise rests orders on the order book, the system allocates/debits/checks-out an amount of risk units to the market participant, in relation to the pending quote/resting order, based on the risk thereof. The amount/block of risk units allocated for a given transaction may be fixed or may vary depending on parameters of the transaction, government or other regulation, policies of the Exchange or market participant or the organization to which they belong, characteristics of the market participant or other factors or combinations thereof. If the pending transaction/resting order is terminated, either cancelled or completed/matched/executed, the allocated risk units may be returned/credited/checked-in to the risk account and thereby be available for future transactions. Alternatively, once consumed, a unit of risk may not be re-used, either permanently, for a period of time or other metric, thereby acting as a limit control. If the risk account is depleted, actions may be taken such as alerting the Exchange and/or the market participant, preventing the market participant from issuing more actionable quotes, submitting new orders, or combinations thereof. In one embodiment, the market participant may be able to receive or purchase an additional allocation of risk units. For example, when warranted, they may earn or are awarded more risk units, such as if their credit rating improves or they post an additional bond or collateral. Further, the risk account may reset, either based on a time limit, a transactional limit or a combination thereof, restoring the risk balance. This may be used in systems where a market making market participant is only protected from over-extending themselves over a defined time window, number of transactions or combination thereof.

In implementation, a supervisory process, coupled with the risk bank, monitors the transaction flow and allocates or de-allocates risk unit from the various risk accounts in the risk bank. In one embodiment, the allocation/de-allocation occurs in real time, allowing for real-time transaction risk processing. Alternatively, the allocation/de-allocation process occurs in non-real-time so as to avoid impeding transaction flow. In this case, depletions of a market participant's risk account are logged and mitigating measures are enacted after the fact, such as at the end of the trading day. In yet another alternative embodiment, the allocation/de-allocation process occurs in non-real time so as not to impede transaction flow until the level of risk units remaining in the risk account falls below a particular threshold. At that point, the process becomes real-time, allocating and de-allocating risk units so as to ensure that the market participant does not over-extend themselves.

In one embodiment, the fluctuations in the level of risk units in the risk account are monitored. For example, large swings in the risk balance are flagged as an indication of a problem. These fluctuations, or deltas, may be accumulated across periods where the risk balance is reset.

In one embodiment, the amount of risk allocated for a given transaction is fixed, e.g. based on the order quantity or number of contracts. Alternatively, the amount of risk allocated may be dynamic. For example, in determining the amount of risk units to allocate for a given transaction, the system may look at the parameters of the transaction, as well as other transactions, such as total executed quantity, the number of contracts, the number of fills, the number of quotes at least filled once, value/settlement date, e.g. for a forward-type product, such as an FX contract, the settlement date of the obligations therein, or combinations thereof. These parameters, or derivative values thereof, such as an absolute value or running average across multiple transactions, may be analyzed over a particular fixed or variable time period, such as one minute, one hour or the trading day. Alternatively, or in addition to, characteristics of the trading entity may be evaluated in determining the amount of risk allocated, such as the credit rating/history of the market participant and/or the organization on behalf of whom they trade, most recent margin account status, past performance metrics, or combinations thereof. Further, risk allocation may occur on a progressive basis, e.g. the amount of risk allocated may increase with each subsequent transaction, based on the number of outstanding transactions or the frequency of transactions, reflecting the extent of the trading entity's overall exposure and the cumulative risk involved.

The determination/allocation, as well as any additional allocations, of risk may be made based, for example, on a credit and/or historical activity evaluation of the market participant, by the Exchange, a governmental or regulatory entity, and/or by another entity who is responsible or liable for the actions of the market participant such as a risk manager, broker, dealer or other party for whom/on behalf of which the market participant participates in the market or who may be ultimately responsible for any losses, e.g. should the market participant be unable to cover such losses.

FIG. 7 depicts a block diagram of an exemplary system 700 for managing risk undertaken by market participants 104/106 transacting via an Exchange/electronic trading system 100, such as via devices 114, 116, 118, 120, according to one embodiment. The system 700 includes a risk management system 702, which may be implemented as the risk management module 134 of FIG. 1, which includes a risk allocation processor 704, a transaction processor 708 and a transaction handling processor 710, all coupled with the electronic trading system 100 and further coupled with an account database 706, which may be a part of the Account Data Module 104 or separate therefrom.

The risk allocation processor 704 is operative to allocate one or more amounts of risk to the market participant for use in covering transactions as will be described, the allocated amount of risk being stored in an account, e.g. a “risk account” in the account database 706, also referred to herein as a risk bank. In one embodiment, the risk allocation processor 704, under the direction of the Exchange, risk manager or other entity as described above, allocates an amount of risk based on a credit rating or other evaluation of the market participant 104/106. Alternatively, or in addition thereto, the risk allocation processor 704 allocates an amount of risk based on the maximum liability the market participant may be expected to satisfy. The amount of risk that is allocated may be for a fixed or variable period of time or for a fixed or variable number of transactions, or a combination thereof, after the elapse/consumption of which, the amount is reset or reallocated. Alternatively, the allocation may be a one time allocation. It will be appreciated that the amount of risk allocated to the market participant 104/106 may be arbitrarily/subjectively determined by the Exchange, risk manager or other entity, such as according to judgment or comfort level, and that all methods of determining how much risk to allocate, whether subjective and/or objective, are contemplated herein. For example, a new/inexperienced or probationary market participant 104/106 may be allocated a substantially reduced amount of risk irrespective of their credit rating or historical activity.

The transaction processor 708 monitors transactions by the market participants undertaken with the electronic trading system 100 and reduces, debits or deducts from the stored allocated amount of risk, an amount based on a transaction proposed by the market participant. It will be appreciated that in an alternate implementation, the risk allocation may represent a threshold or comparative value and that per-transaction risk allotments may be accumulated in an account, which may start at zero, until the accumulation meets or exceeds the threshold value. In one embodiment, the proposed transactions are reviewed and used as the basis for risk account adjustments. Where the transaction is for a given quantity, e.g. number of contracts, and the risk units are measured in quantity units, the amount of risk debited may be equal to, or otherwise based on, the quantity specified in the transaction. Alternatively, completed pending transactions, e.g. the proposed transaction has been accepted but not yet matched, may be reviewed. The transaction processor 708 then updates, or otherwise stores the reduced allocated amount of risk in the account in place of the stored allocated amount of risk, effectively reducing the amount of risk allocated in the account for future transactions as will be described. In one embodiment, the amount of risk deducted from the account is fixed, e.g. each transaction causes the same amount of risk to be deducted. Alternatively, the amount of risk that is deducted may be based on the proposed transaction, e.g. based on the quantity or number of contracts, based on a risk assessment of the proposed transactions, such as an assessment of the credit worthiness or transaction history of the transacting parties and/or the volatility of the particular market, or other factors or combinations thereof. As described above, and further described below, the amount risk deducted may be based on the quantity specified by the transaction such as the number of lots or number of contracts or based on the magnitude of the value thereof, e.g. based on the number lots or contracts multiplied by the transaction price.

In one embodiment, the transaction processor 708 is further operative to determine that the proposed transaction has been concluded, e.g. matched and completed, and, based thereon, increase the stored allocated amount risk. In this way, the risk amounts are only allocated for open transactions that have not yet been accepted/matched. The risk amount is then credited back to the risk account in the account database 1106 upon conclusion of the transaction and, thereby, elimination of the risk therein. As will be appreciated, once a transaction has been completed, there may be other credit control mechanism in place to assure the market participant complies with their obligations, e.g. margin, performance bonds, etc. In one embodiment, the risk amount maybe credited back to the risk account after a time delay, such as to act as a control to manage the rate of order submission by the market participant 104/106.

The transaction handling processor 710 further includes a monitor processor 712 coupled with the account database and operative to determine if the stored allocated amount of risk has been depleted by the reductions made by the transaction processor 708. In one embodiment, the monitor processor 712 may generate a warning message, such as via electronic mail or via the market participant's trading interface or other means such as via drop copy (described below), to the market participant, and/or other responsible entity, that the stored allocated amount of risk is depleted and/or nearing (based on a defined threshold) depletion. The threshold for the warning may be fixed, defined by the market participant 104/106, a risk manager, the Exchange, may vary, such as based on the credit history of the market participant 104/106, or combinations thereof.

In response to the depletion of the risk account of the market participant 104/106, or when the amount of risk in the account falls below a defined threshold, as determined by the monitor processor 1112 (at the direction of the Exchange and/or other responsible entity), the transaction handling processor 710 is operative to take an action in accordance with the determination. Exemplary actions include alerting, via email, drop copy, or a user interface, the market participant or other entity, such as a risk manager, when the stored allocated amount of risk has been depleted or is near depletion, blocking or rejecting the proposed transaction when the stored allocated amount of risk has been depleted or is near depletion, or combinations thereof. With respect to acting when the allocated amount of risk is near depletion, this may be measured based on a threshold defined by the Exchange or other responsible entity, and/or may be defined based on an amount of risk necessary to cover a subsequent transaction. Where the debited amount of risk varies by transaction, the risk amount necessary to cover a subsequent transaction may be determined as the amount necessary to cover the average transactional risk, e.g. based on historical activity of the market participant or the market generally, the minimum transactional risk, the maximum transactional risk, or a combination thereof.

In one embodiment the risk management system 702 includes one or more processors (not shown), one or more memories (not shown) and/or other non-transitory storage media coupled with the one or more processors and a network interface (not shown) coupled with the one or more processors and a network operative to facilitate communications therebetween and with the electronic trading system 100 and market participants 104/106. Each of the risk allocation processor 704, transaction processor 708, transaction handling processor 710, monitor processor 712 and account database 706 may be implemented in hardware, software/logic stored in a non-transitory computer readable medium, or a combination thereof. While various components are discussed in terms of their discrete functions, it will be further appreciated that one or more of the described functions may be implemented in a single component or any one function may be performed by multiple discrete components, or combinations thereof, and is implementation dependent.

For example, the risk management system 702 may include a processor and a memory coupled with the processor, wherein: first logic is stored in the memory and executable by the processor to allocate an amount of risk to the market participant, the allocated amount of risk being stored in an account in the memory; second logic is stored in the memory and executable by the processor to reduce the stored allocated amount of risk based on a transaction proposed by the market participant; and third logic is stored in the memory and executable by the processor to determine if the stored allocated amount of risk has been depleted by the reduction and act in accordance with the determination.

FIG. 8 depicts a flow chart showing exemplary operation of the system 702 of FIG. 7 according to one embodiment. The operations of protecting a market participant participating in a market include allocating an amount of risk to the market participant, the allocated amount of risk being stored in an account (block 802). In one embodiment, the allocation is based on a credit rating of the market participant. Alternatively, or in addition thereto, the allocation may be based on the maximum liability the market participant may be expected to satisfy. The operations further include reducing the stored allocated amount of risk based on a transaction proposed by the market participant (block 804), such as by determining a first amount of risk associated with the proposed transaction and deducting the first amount of risk from the stored allocated amount of risk. Further, the reduced allocated amount of risk may be stored in the account in place of the stored allocated amount of risk. In one embodiment, the first amount is fixed. Alternatively, the first amount may be based on the proposed transaction. The operations also include determining if the stored allocated amount of risk has been depleted by the reduction (block 806) and acting in accordance therewith (block 808). The determining may further include warning the market participant that the stored allocated amount of risk is nearing depletion. The acting may include alerting the market participant when the stored allocated amount of risk has been depleted and/or blocking the proposed transaction when the stored allocated amount of risk has been depleted. In one embodiment, the operations further include determining that the proposed transaction has been concluded and increasing the stored allocated amount risk based thereon. In another alternative embodiment, the amount of risk may be re-allocated to the market participant after an elapse of a period of time.

In an alternative embodiment, the system 702, described above, may provide more granular credit controls, instead of or in addition to those described above, which add an additional or alternative layer of control, recognizing that managing a market participant's 104/106 overall risk exposure may provide insufficient controls to establish potential loss with certainty, fail to mitigate loss of a market participant's entire credit allotment, and unduly restrict less risky behavior. For example, an overall credit limit may still allow a market participant to concentrate their risk of exposure with respect to price and/or correlated products such that the entirety of their credit limit may be at risk. One solution may simply be to lower the credit limit but this may unduly restrict the market participant's legitimate activities. Accordingly, the embodiments described below provide a mechanism by which a market participant's ability to concentrate their risk exposure may be managed by the Exchange, the market participant, regulatory or governmental agencies, or other entity responsible for the activities of the market participant, such as a risk manager, broker, clearing member, etc.

In one embodiment, the credit controls described herein may be provided and maintained by an Exchange, such as the Chicago Mercantile Exchange (“CME”). CME provides the Globex Credit Controls which provide pre-execution risk controls that enable administrators to set credit limits through the CME Globex Credit Controls (GC2) tool. Risk administrators are able to define trading limits and select real-time actions if those limits are exceeded, including e-mail notification, order blocking and order cancellation.

Generally, the disclosed embodiments enable credit limits to be specified at each price level or group of price levels in a market. As will be seen, in concert with the market protection mechanism described above, which act to slow or pause a market upon detection of an extreme market event, the disclosed embodiments enable a market participant 104/106, or other party, to establish potential loss with substantial certainty, mitigate losses which may occur, and reduce restrictions on less risky behavior. In particular, for example, by defining limits on the number of open contracts which may be concentrated at particular price levels based on the threshold limit of how fast the market can change before trading is interrupted by the market protection mechanisms, a market participant or risk manager can more realistically determine their maximum risk of loss. This threshold limit effectively defines how many price levels, i.e. the trades resting there at, could be subject to execution under rapid market movement, i.e. movement more rapid then the response time of the market participant, before the market protection mechanism interrupts trading, allowing the market participant to cancel their remaining open orders. In other words, this allows definition of the maximum risk or worst case traded quantity for a sweep of liquidity for liquidity providers. Where resting orders are dispersed across price levels, the market protection mechanism ensures that only a limited number of resting orders may be at risk to disadvantageous execution before the market participant can respond. This, for example, allows for exposure control but may still allow a market participant to provide liquidity across the order book, maximizing the market participant's ability to utilize their available credit to provide liquidity.

Furthermore, the disclosed credit control mechanism may act to reject orders at price levels where credit has been exhausted which further ensures that the available liquidity is actionable by other market participants. In addition, the disclosed credit control mechanism may act as a further safety check against errors such as accidental repeated submission of an order, e.g. unintentional order submissions, or orders which contain errors such as an incorrect quantity, i.e. unintentional extra zeroes.

FIG. 9 depicts a block diagram 902 of the risk management module 134 depicted in FIG. 7 according to one embodiment, which in an exemplary implementation, as described above, is implemented as part of the exchange computer system 100 described above. As used herein, an electronic trading system 100, i.e. exchange, includes a place or system that receives and/or executes orders. It will be appreciated that the disclosed embodiments may be implemented by or in conjunction with other modules or components of the electronic trading system 100. While the disclosed embodiments may be described with respect to a separate implementation for each match engine, market or order book, it will be appreciated that the disclosed embodiments may also be implemented across the entire electronic trading system 100 such as for example, by further denoting incoming orders by their intended market and separately processing orders received for a given market as described herein or by identifying incoming orders for correlated markets and accounting therefore as will be described.

In particular, FIG. 9 depicts a block diagram of a system 902, which may also be referred to as an architecture, for managing risk undertaken by market participants or otherwise protecting a market participant, or other responsible entity as was described, participating in one or more markets for financial products, which may be correlated. Each market comprises a set of prices/price levels at which transactions for the financial product may be proposed, typically further defined by a price increment, referred to as a “tick”, which is the minimum difference between price levels. The markets are provided/managed by the electronic trading system 100 which receives incoming orders to trade the financial products, received via a network, such as the network 126 of FIG. 1, from a plurality of market participants 104/106. Wherein, as described, the electronic trading system 100 comprises a match engine 106 which implements a market for an associated financial instrument by being operative to attempt to match an incoming order for a transaction for the associated financial instrument with at least one other previously received but unsatisfied order for a transaction counter thereto for the associated financial instrument, to at least partially satisfy one or both of the incoming order or the at least one other previously received order.

The system 902 includes a risk allocation processor 704, which may be implemented as a separate component or as one or more logic components, such as on an FPGA which may include a memory or reconfigurable component to store logic and processing component to execute the stored logic, or as first logic 908, e.g. computer program logic, stored in a memory 906, or other non-transitory computer readable medium, and executable by a processor 904, such as the processor 402 and memory 404 described below with respect to FIG. 4, to cause the processor 904 to, or otherwise be operative to, allocate, for each of a plurality of market participants, an amount, which may be the same or different for each, of risk to each of a plurality of subsets of one or more price levels of the set of price levels. The subsets may be overlapping or non-overlapping and may contain consecutive or non-consecutive price levels. Furthermore, each subset may contain price levels from different markets, i.e. for different financial products, such as financial products which are correlated in some manner, e.g. based on price movement, based on a correlated risk of loss, etc. The risk allocation processor 704 may be coupled with an account database 706, which may be stored in the memory 906 or elsewhere, and may be implemented as the account data module 104, which stores and maintains the risk account balances for the market participants 104/106.

In one embodiment, each price level of the set of price levels is contained in only one subset of price levels. In one embodiment, each subset of price levels may contain only one price level.

In one embodiment, the risk allocation processor 704 may be further operative to allocate the amount of risk based on a credit rating of the market participant, an estimated maximum liability of the market participant, or a combination thereof. It will be appreciate that the risk allocation processor 704 may be coupled with a user interface (not shown) which allows a market participant, or other responsible entity, to define the allocated risk amounts. For example, such an interface may includes graphic user interface which presents a grid view of price levels and allows the user to set or otherwise allocate risk amounts as described herein.

In one embodiment, the risk allocation processor 704 may be further operative to determine that the first transaction has been concluded, i.e. at least partially matched with another proposed transaction at least partially counter thereto or by being canceled, and increase the allocated amount risk of all/any of the subsets of price levels which contain the first price level based thereon.

In one embodiment, the risk allocation processor 704 may be further operative to increase the allocated amount of risk of all/any of the subsets of price levels which contain the first price level after an elapse of a period of time after receipt of the first transaction, or, alternatively or in addition thereto, after another event such as a pause in market activity, market close, etc.

In one embodiment, the risk allocation processor 704 is further operative to periodically reallocate the amount of risk to each of the plurality of subsets of price levels. It will be appreciated that the allocated amounts of risk and/or price levels within the subsets may be different with each periodic reallocation.

The system 902 further includes a transaction processor 708, which may be implemented as a separate component or as one or more logic components, such as on an FPGA which may include a memory or reconfigurable component to store logic and processing component to execute the stored logic, or as second logic 910, third logic 912, fourth logic 914, and fifth logic 916, e.g. computer program logic, stored in a memory 806, or other non-transitory computer readable medium, and executable by a processor 904, such as the processor 402 and memory 404 described below with respect to FIG. 4, to cause the processor 904 to, or otherwise be operative to: receive, from a first market participant 104/106 of the plurality of market participants, a first transaction at a first price level within a first subset proposed by the market participant but not yet matched with another proposed transaction counter thereto; reduce, based on the first transaction, the allocated amount of risk of the first market participant associated with any/all of the subsets of price levels of the set of price levels containing the first price level, such as by adjusting the balances stored in the account database 706; receive a second transaction for the same financial product as the first transaction or a financial product correlated therewith, at a second price level, which may the same as the first price level, in same subset as first price level, or in a completely different price level, proposed but not yet matched with another proposed transaction counter thereto, the second transaction having been proposed prior to the conclusion, i.e. matching or cancellation, of the first transaction; and determine all of the subsets of price levels of the set of price levels which contain the second price level.

In one embodiment, the second transaction is received from the first market participant. However, in an alternate embodiment, the second transaction may be received from another market participant which shares a common credit limit. For example, traders working for the same broker may be subject to common risk allocations to prevent overall risk exposure of the broker.

The system 902 further includes a monitor processor 712, which may be implemented as a separate component or as one or more logic components, such as on an FPGA which may include a memory or reconfigurable component to store logic and processing component to execute the stored logic, or as sixth logic 918, e.g. computer program logic, stored in a memory 906, or other non-transitory computer readable medium, and executable by a processor 904, such as the processor 402 and memory 404 described below with respect to FIG. 4, to cause the processor 904 to, or otherwise be operative to, prior to the conclusion, i.e. matching, partial or otherwise, with other subsequently received transactions counter thereto or cancellation, of the first and second transactions, determine, such as by evaluating the stored risk balances in the account database 706, if the allocated amount of risk of all/any of the subsets of price levels which contain the second price level has been depleted or otherwise consumed by the reduction based on the first transaction, i.e. reduced to zero or reduced to an amount insufficient to cover the second transaction.

In one embodiment, the monitor processor 712 is further operative to determine a first amount of risk associated with the first transaction and reduce the allocated amount of risk in accordance therewith. In one embodiment, the first amount is fixed. Alternatively it may be variable. Wherein the allocated amount of risk is measured in quantity units, the first amount may be determined based on a quantity specified by the first transaction, e.g. lots, number of contracts, delta, covariance of correlated products, etc. In one embodiment, the first amount is computed based on the first transaction.

The system 902 further includes a transaction handling processor 710, which may be implemented as a separate component or as one or more logic components, such as on an FPGA which may include a memory or reconfigurable component to store logic and processing component to execute the stored logic, or as seventh logic 920, e.g. computer program logic, stored in a memory 906, or other non-transitory computer readable medium, and executable by a processor 904, such as the processor 402 and memory 404 described below with respect to FIG. 4, to cause the processor 904 to, or otherwise be operative to act on the second transaction in accordance therewith.

In one embodiment, the transaction handling processor 710 may be further operative to transmit a warning message to the market participant 104/106, or other responsible entity, that the allocated amount of risk is nearing depletion when the allocated amount of risk falls below a threshold amount of risk or otherwise has been depleted. Messages may be communicated via a trader user interface, email, drop copy function or other mode of communication.

In one embodiment, the transaction handling processor 710 may be further operative to reject the second transaction when the allocated amount of risk of all/any of the subsets of price levels which contain the second price level has been depleted.

In one embodiment, the monitor processor 712 may be further operative to monitor for fluctuations of the stored allocated amount of risk and wherein the transaction handling processor 710 may be further operative to act on the second transaction in accordance therewith when the magnitude of the fluctuations exceeds a threshold.

In one embodiment, by defining the subsets of price levels to include price levels among different correlated products, transactions proposed by a market participant for one product may restrict the transactions they can propose in the other correlated products by depleting the available risk amount for the subset of price levels. This effectively permits management of the market participant's ability to concentrate their risk of loss in a set of products likely, for example, to incur similar loss events.

In one embodiment wherein, as described above, the electronic trading system 100/market is operative to attempt to match an incoming transaction for the financial product with a previously received but unsatisfied transaction counter thereto, the market may be characterized by a market parameter which may change over time based on results of the attempted matching, the market further featuring a market protection mechanism which is operative to at least interrupt or otherwise pause, such as by placing the market in reserve state, the attempted matching of incoming transactions when a rate of change of the market parameter deviates from, or otherwise exceeds, a threshold rate. The risk allocation processor 908 may system 902 may further be operative, such as via the inclusion of eighth logic 922, to determine, based on the threshold for which a deviation of the market parameter therefrom will cause the market to at least interrupt the attempted matching, the number of price levels of the set of price levels within each of the plurality of subsets of price levels. In one embodiment, the risk allocation processor is coupled with the velocity logic described above and accesses the velocity logic's threshold value. As described above, this permits a market participant 104/106, or other responsible entity, to manage their risk exposure within a more narrow window. In embodiments enabling risk management among correlated products, this may further permit a market participant to cancel their resting orders in one market based on rapid changes in a correlated market.

In one embodiment, as was described above, the threshold comprises a magnitude of a number of price levels a last traded price of the financial product may change over a defined period of time.

In one embodiment, the market parameter comprises a bid price of the product, an ask price of the product, a last traded price of the product, a last traded quantity of the product, a volatility of the product, market attribute, delta, present value, or a combination thereof.

In one embodiment, the transaction handling processor 710 is further operative to allow, when attempted matching of incoming transactions has at least been interrupted, a market participant 104/106 to cancel previously submitted transactions which have not yet been concluded, i.e. matched or cancelled. It will be appreciated that this functionality may alternatively be provided by other functions of the electronic trading system 100 which permit order cancellation.

In one embodiment, as was described above, the allocation of the amounts of risk to all of the plurality of subsets of price levels may be limited to a defined total amount of risk, which may be assigned to the market participant 104/106 or group thereof, to a particular product, set of products, or combinations thereof. In one embodiment, the monitor processor 712 is further operative to, prior to the conclusion, i.e. matching or cancellation, of the first and second transactions, determine if the total amount of risk has been depleted by the reduction based on the first transaction and wherein the transaction handling process or further operative to act on, e.g. reject, the second transaction in accordance therewith.

In one embodiment, functionality akin to the market protection mechanism described above may be provided but as a system which provides a warning to a market participant 104/106 based on their own specification. In this system, which may be implemented in conjunction with any of the above embodiments, a threshold rate of market change may be defined which, if exceeded, will alert the particular market participant 104/106 so that they may take action in accordance therewith. This threshold value may further be utilized to define the price level risk allocations. In particular, wherein the market/electronic trading system 100 is operative to attempt to match an incoming transaction for the financial product with a previously received but unsatisfied transaction counter thereto, the market being characterized by a market parameter, e.g. last traded price, volatility, profit/loss, or a combination thereof, which may change over time based on results of the attempted matching, and further wherein the transaction processor is further operative to allow the market participant to specify a rate of change of the market parameter, the number of price levels of the set of price levels within each of the plurality of subsets of price levels being based thereon. The market participant may specify an overall rate, a threshold number of price levels and/or time limit. This effectively provides a “personal” velocity logic type function to the market participant 104/106.

FIG. 10 depicts a flow chart showing operation of the system 902 of FIG. 9. In particular FIG. 10 shows a computer implemented method of protecting a market participant, or other responsible entity as was described, participating in one or more markets for financial products, which may be correlated. Each market comprises a set of prices/price levels at which transactions for the financial product may be proposed, typically further defined by a price increment, referred to as a “tick”, which is the minimum difference between price levels.

The operation of the system 902 includes: allocating, by a processor for each of a plurality of market participants, an amount, which may be the same or different for each, of risk to each of a plurality of subsets of one or more price levels of the set of price levels [Block 1002]. The subsets may be overlapping or non-overlapping and may contain consecutive or non-consecutive price levels. Furthermore, each subset may contain price levels from different markets, i.e. for different financial products, such as financial products which are correlated in some manner, e.g. based on price movement, based on a correlated risk of loss, etc.

In one embodiment, the operation of the system 902 further includes periodically reallocating the amount of risk, the same or a different amount, to each of the plurality of subsets of price levels. With each reallocation, the amounts and/or subsets may be different.

In one embodiment, each price level of the set of price levels is contained in only one subset of price levels. In one embodiment, each subset of price levels may contain only one price level.

In one embodiment the operation of the system 902 further includes allocating, by the processor the amount of risk based on a credit rating of the market participant, an estimated maximum liability of the market participant, or a combination thereof. The allocation may be under the control, entirely or partially, of the market participant 104/106, the Exchange or another responsible entity, or combination thereof.

In one embodiment the operation of the system 902 further includes determining, by the processor, that the first transaction has been concluded, i.e. matched or cancelled, and increasing the allocated amount risk of all/any of the subsets of price levels which contain the first price level based thereon.

In one embodiment the operation of the system 902 further includes increasing, by the processor, the allocated amount of risk of all/any of the subsets of price levels which contain the first price level after an elapse of a period of time after receipt of the first transaction, or, alternatively or in addition thereto, after another event such as a pause in market activity, market close, etc.

The operation of the system 902 further includes: receiving, by the processor from a first market participant of the plurality of market participants, a first transaction at a first price level within a first subset of price levels, the first transaction having been proposed by the market participant but not yet matched with another proposed transaction counter thereto [Block 1004]; reducing, by the processor based on the first transaction, the allocated amount of risk of the first market participant associated with all/any of the subsets of price levels of the set of price levels containing the first price level [Block 1006]; receiving, by the processor, a second transaction at a second price level, which may the same as the first price level, in same subset as first price level, or in a completely different price level, proposed but not yet matched with another proposed transaction counter thereto, the second transaction having been proposed prior to the conclusion, i.e. matching or cancellation, of the first transaction [Block 1008]; and determining, by the processor, all of the subsets of price levels of the set of price levels which contain the second price level [Block 1010].

In one embodiment, the second transaction is received from the first market participant. However, in an alternate embodiment, the second transaction may be received from another market participant which shares a common credit limit. For example, traders working for the same broker may be subject to common risk allocations to prevent overall risk exposure of the broker.

In one embodiment, the reducing further comprises determining a first amount of risk associated with the first transaction and reducing the allocated amount of risk in accordance therewith. In one embodiment, the first amount is fixed.

Alternatively it may be variable. Wherein the allocated amount of risk is measured in quantity units, the first amount may be determined based on a quantity specified by the first transaction, e.g. lots, number of contracts, delta, covariance of correlated products, etc. In one embodiment, the first amount is computed based on the first transaction.

The operation of the system 902 further includes: prior to the conclusion, i.e. matching with other subsequently received transactions counter thereto, of the first and second transactions or cancellation, determining, by the processor, if the allocated amount of risk of all/any of the subsets of price levels which contain the second price level has been depleted or otherwise consumed by the reduction based on the first transaction, i.e. reduced to zero or reduced to an amount insufficient to cover the second transaction [Block 1012]; and acting, by the processor, on the second transaction in accordance therewith [Block 1014].

In one embodiment, the operation of the system 902 further includes transmitting, by the processor, a warning message to the market participant that the allocated amount of risk is nearing depletion when the allocated amount of risk falls below a threshold amount of risk or otherwise has been depleted.

In one embodiment, the acting further comprises rejecting the second transaction when the allocated amount of risk of all/any of the subsets of price levels which contain the second price level has been depleted.

In one embodiment, the operation of the system 902 further includes monitoring, by the processor, for fluctuations of the stored allocated amount of risk and acting, by the processor, on the second transaction in accordance therewith when the magnitude of the fluctuations exceeds a threshold.

In one embodiment, the allocation of the amounts of risk to all of the plurality of subsets of price levels may be limited to a defined total amount of risk, assigned to the market participant 104/106 or a group thereof, and/or to one or more financial products or subsets thereof.

In one embodiment, the operation of the system 902 includes, prior to the conclusion, i.e. matching or cancellation, of the first and second transactions, determining, by the processor, if the total amount of risk has been depleted by the reduction based on the first transaction and acting on, by the processor, such as by rejecting, the second transaction in accordance therewith.

In one embodiment, wherein the market is operative to attempt to match an incoming transaction for the financial product with a previously received but unsatisfied transaction counter thereto, the market being characterized by a market parameter which may change over time based on results of the attempted matching, the market being further operative to at least interrupt, e.g. pause or place market in reserve state, the attempted matching of incoming transactions when a rate of change of the market parameter deviates from, or otherwise exceeds, a threshold, the operation of the system 902 may further include determining, by the processor based on the threshold for which a deviation of the market parameter therefrom will cause the market to at least interrupt the attempted matching, the number of price levels of the set of price levels within each of the plurality of subsets of price levels. In one embodiment, the threshold comprises a magnitude of a number of price levels a last traded price of the financial product may change over a defined period of time. The operation of the system 902 may further include allowing, by the processor when attempted matching of incoming transactions has at least been interrupted, a market participant to cancel previously submitted transactions which have not yet been concluded, i.e., matched or cancelled. In one embodiment, the market parameter comprises a bid price of the product, an ask price of the product, a last traded price of the product, a last traded quantity of the product, a volatility of the product, market attribute, delta, present value, or a combination thereof.

In one embodiment, wherein the market is operative to attempt to match an incoming transaction for the financial product with a previously received but unsatisfied transaction counter thereto, the market being characterized by a market parameter, such as last traded price, volatility, profit/loss, or a combination thereof, which may change over time based on results of the attempted matching, the operation of the system 902 may further include allowing, by the processor, the market participant to specify a rate of change of the market parameter, the number of price levels of the set of price levels within each of the plurality of subsets of price levels being based thereon. The rate of change may be specified as an overall rate, a threshold number of price levels, and/or time limit.

It will be appreciated that the alerts and other messages transmitted by the disclosed embodiments may be transmitted using a “drop copy” function which is a service that allows market participants to receive real-time copies of CME Globex execution reports and reject messages as they are sent over iLink sessions. Features include the ability to monitor orders and activity, as well as aggregate execution and reject messages. This would permit risk managers, for example, to receive messages related to the market participants they are responsible for in order to monitor activities and manage risk allocations, etc.

In one embodiment, price level subsets may be automatically redefined at different times, such as during regular trading hours, electronic trading hours, etc. and/or as incoming orders are received in order to manage resting order concentration. Furthermore, mechanisms may be implemented to alert a market participant as to the price levels where they have available risk amounts or otherwise to inform the market participant of their risk consumption and availability.

As an example, assume the following:
1. A market for product X which has a price range of 1-12 in 1 tick increments, i.e. there are 10 price levels
2. The Velocity Logic threshold is 3 ticks/millisecond

Further assume that for a market participant, Trader 1, a total risk allocation, measured in the number of contracts, is allocated, e.g. by a risk manager thereof, of 50 contracts is allocated. Furthermore, the risk manager defines subsets of price levels, based on the velocity logic threshold, to include 3 price levels. The subsets are then (1,2,3) (4,5,6) (7,8,9) and (10,11,12). Further, the risk manager defines that Trader 1 may not place orders totaling more than 15 contracts in any subset of price levels.

As can be seen, using the disclosed embodiments, if Trader 1 places an order to buy or sell 10 contracts at price level 2, a subsequent order to buy or sell up to 5 contracts may be placed at price levels 1, 2 or 3. However, a subsequent order in excess of 5 contracts at price levels 1, 2, or 3 may be rejected while such an order, assuming it was for 15 or less contracts could be placed at any other price level. If the trader placed orders totaling 15 contracts at price level 2, price level 4 and price level 7, they could only place an order for up to 5 contracts and price levels 10, 11 or 12 as this would deplete their total allocation of risk. Notice that in this scenario, if the market experiences a rapid change exceeding 3 ticks/millisecond, the maximum loss for Trader 1 would be 30 contracts, assuming the change occurred from price levels 2 to 4, until the market was placed in reserve and Trader 1 was afforded the opportunity to cancel their remaining open orders. As can be seen, then, despite the overall credit allocation of the 50 contracts (and even if it was more), the maximum loss of Trader 1 will be 30 contracts.

In an alternate embodiment, each price level may be allocated a risk amount where that amount is reduced for any transaction at the price level or within the defined number of ticks thereof. That is, each price level (base price level) is included in a subset of price levels which further includes all price levels within a defined range of ticks from the base price level. As such, each subset of price levels overlaps with one or more other subsets of price levels based on the tick range, i.e. each price level may belong to more than one subset. When the risk allotment of a given price level is depleted (by orders placed at that price level or at other price levels in any of the subsets to which the depleted price level belongs), the credit control mechanisms described herein may apply to reject further orders at that price level. In this manner, using overlapping price level subsets, the risk of loss due to a rapid market change can be contained to a specific subset of price levels providing a finer degree of credit control by preventing losses which may be incurred when the market participant concentrates their risk at the boundary price levels of the subsets as demonstrated in the above example.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an exchange 100 for financial instruments.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A system for protecting a market participant participating in a market for a financial product, the market comprising a set of price levels at which transactions for the financial product may be proposed, the system comprising:
first logic stored in a memory and executable by a processor coupled therewith to cause the processor to allocate, for each of a plurality of market participants, an amount of risk to each of a plurality of subsets of price levels of the set of price levels;
second logic stored in the memory and executable by the processor to cause the processor to receive, from a first market participant of the plurality of market participants, a first transaction at a first price level within a first subset of price levels, the first transaction having been proposed by the market participant but not yet matched with another proposed transaction counter thereto;
third logic stored in the memory and executable by the processor to cause the processor to reduce, based on the first transaction, the allocated amount of risk of the first market participant associated with all of the subsets of price levels of the set of price levels containing the first price level;
fourth logic stored in the memory and executable by the processor to cause the processor to receive a second transaction at a second price level proposed but not yet matched with another proposed transaction counter thereto, the second transaction having been proposed prior to the conclusion of the first transaction;
fifth logic stored in the memory and executable by the processor to cause the processor to determine all of the subsets of price levels of the set of price levels which contain the second price level;
sixth logic stored in the memory and executable by the processor to cause the processor to, prior to the conclusion of the first and second transactions, determine if the allocated amount of risk of all of the subsets of price levels which contain the second price level has been depleted by the reduction based on the first transaction; and
seventh logic stored in the memory and executable by the processor to cause the processor to act on the second transaction in accordance therewith.

2. The system of claim 1 wherein the market is operative to attempt to match an incoming transaction for the financial product with a previously received but unsatisfied transaction counter thereto, the market being characterized by a market parameter which may change over time based on results of the attempted matching, the market being further operative to at least interrupt the attempted matching of incoming transactions when a rate of change of the market parameter deviates from a threshold, the system further comprising:
eighth logic stored in the memory and executable by the processor to cause the processor to determine, based on the threshold for which a deviation of the market parameter therefrom will cause the market to at least interrupt the attempted matching, the number of price levels of the set of price levels within each of the plurality of subsets of price levels.

3. A system for protecting a market participant participating in a market for a financial product, the market comprising a set of price levels at which transactions for the financial product may be proposed, the system comprising:
a risk allocation processor operative to allocate, for each of a plurality of market participants, an amount of risk to each of a plurality of subsets of price levels of the set of price levels; and
a transaction processor coupled with the risk allocation processor and operative to:
receive, from a first market participant of the plurality of market participants, a first transaction at a first price level within a first subset of price levels, the first transaction having been proposed by the market participant but not yet matched with another proposed transaction counter thereto;
reduce, based on the first transaction, the allocated amount of risk of the first market participant associated with all of the subsets of price levels of the set of price levels containing the first price level;
receive a second transaction at a second price level proposed but not yet matched with another proposed transaction counter thereto, the second transaction having been proposed prior to the conclusion of the first transaction;
determine all of the subsets of price levels of the set of price levels which contain the second price level; and wherein the system further comprises:
a monitor processor coupled with the transaction processor and operative to, prior to the conclusion of the first and second transactions, determine if the allocated amount of risk of all of the subsets of price levels which contain the second price level has been depleted by the reduction based on the first transaction; and
a transaction handling processor coupled with the monitor processor and operative to act on the second transaction in accordance therewith.

4. The system of claim 3 wherein the risk allocation processor is further operative to periodically reallocate the amount of risk to each of the plurality of subsets of price levels.

5. The system of claim 3 wherein each price level of the set of price levels is contained in only one subset of price levels.

6. The system of claim 5 wherein each subset of price levels contains only one price level.

7. The system of claim 3 wherein the second transaction is received from the first market participant.

8. The system of claim 3 wherein the allocation of the amounts of risk to all of the plurality of subsets of price levels is limited to a defined total amount of risk.

9. The system of claim 8 wherein the monitor processor is further operative to, prior to the conclusion of the first and second transactions, determine if the total amount of risk has been depleted by the reduction based on the first transaction and wherein the transaction handling process or further operative to act on the second transaction in accordance therewith.

10. The system of claim 9, wherein the act further comprises rejecting the second transaction when the total amount of risk has been depleted.

11. The system of claim 3 wherein the risk allocation processor is further operative to allocate the amount of risk based on a credit rating of the market participant, an estimated maximum liability of the market participant, or a combination thereof.

12. The system of claim 3, wherein the monitor processor is further operative to determine a first amount of risk associated with the first transaction and reduce the allocated amount of risk in accordance therewith.

13. The system of claim 12, wherein the first amount is fixed.

14. The system of claim 12, wherein the allocated amount of risk is measured in quantity units, the first amount being determined based on a quantity specified by the first transaction.

15. The system of claim 12, wherein the first amount is computed based on the first transaction.

16. The system of claim 3, wherein the transaction handling processor is further operative to transmit a warning message to the market participant that the allocated amount of risk is nearing depletion when the allocated amount of risk falls below a threshold amount of risk.

17. The system of claim 3, wherein the transaction handling processor is further operative to transmit a message to the market participant when the allocated amount of risk has been depleted.

18. The system of claim 3, wherein the transaction handling processor is further operative to reject the second transaction when the allocated amount of risk of all of the subsets of price levels which contain the second price level has been depleted.

19. The system of claim 3 wherein the risk allocation processor is further operative to determine that the first transaction has been concluded and increasing the allocated amount risk of all of the subsets of price levels which contain the first price level based thereon.

20. The system of claim 3 wherein the risk allocation processor is further operative to increase the allocated amount of risk of all of the subsets of price levels which contain the first price level after an elapse of a period of time after receipt of the first transaction.

21. The system of claim 3, wherein the first transaction may be concluded by at least being partially matched with another transaction at least partially counter thereto, or by being canceled.

22. The system of claim 3, wherein the monitor processor is further operative to monitor for fluctuations of the stored allocated amount of risk and wherein the transaction handling processor is further operative to act on the second transaction in accordance therewith when the magnitude of the fluctuations exceeds a threshold.

23. The system of claim 3, wherein the market is operative to attempt to match an incoming transaction for the financial product with a previously received but unsatisfied transaction counter thereto, the market being characterized by a market parameter which may change over time based on results of the attempted matching, the market being further operative to at least interrupt the attempted matching of incoming transactions when a rate of change of the market parameter deviates from a threshold, and further wherein the risk allocation processor is operative to determined, based on the threshold for which a deviation of the market parameter therefrom will cause the market to at least interrupt the attempted matching, the number of price levels of the set of price levels within each of the plurality of subsets of price levels.

24. The system of claim 23 wherein the threshold comprises a magnitude of a number of price levels a last traded price of the financial product may change over a defined period of time.

25. The system of claim 23 wherein the transaction handling processor is further operative to allow, when attempted matching of incoming transactions has at least been interrupted, a market participant to cancel previously submitted transactions which have not yet been concluded.

26. The system of claim 23 wherein the market parameter comprises a bid price of the product, an ask price of the product, a last traded price of the product, a last traded quantity of the product, a volatility of the product, market attribute, delta, present value, or a combination thereof.

27. The system of claim 3 wherein the market is operative to attempt to match an incoming transaction for the financial product with a previously received but unsatisfied transaction counter thereto, the market being characterized by a market parameter which may change over time based on results of the attempted matching, and further wherein the transaction processor is further operative to allow the market participant to specify a rate of change of the market parameter, the number of price levels of the set of price levels within each of the plurality of subsets of price levels being based thereon.

28. The system of claim 27 wherein market parameter comprises volatility, profit/loss, or a combination thereof.

29. A computer implemented method of protecting a market participant participating in a market for a financial product, the market comprising a set of price levels at which transactions for the financial product may be proposed, the method comprising:
allocating, by a processor for each of a plurality of market participants, an amount of risk to each of a plurality of subsets of price levels of the set of price levels;
receiving, by the processor from a first market participant of the plurality of market participants, a first transaction at a first price level within a first subset of price levels, the first transaction having been proposed by the market participant but not yet matched with another proposed transaction counter thereto;
reducing, by the processor based on the first transaction, the allocated amount of risk of the first market participant associated with all of the subsets of price levels of the set of price levels containing the first price level;
receiving, by the processor, a second transaction at a second price level proposed but not yet matched with another proposed transaction counter thereto, the second transaction having been proposed prior to the conclusion of the first transaction;
determining, by the processor, all of the subsets of price levels of the set of price levels which contain the second price level; and
prior to the conclusion of the first and second transactions, determining, by the processor, if the allocated amount of risk of all of the subsets of price levels which contain the second price level has been depleted by the reduction based on the first transaction and acting, by the processor, on the second transaction in accordance therewith.

30. The computer implemented method of claim 29 wherein the allocating further comprises periodically reallocating the amount of risk to each of the plurality of subsets of price levels.

31. The computer implemented method of claim 29 wherein each price level of the set of price levels is contained in only one subset of price levels.

32. The computer implemented method of claim 31 wherein each subset of price levels contains only one price level.

33. The computer implemented method of claim 29 wherein the second transaction is received from the first market participant.

34. The computer implemented method of claim 29 wherein the allocation of the amounts of risk to all of the plurality of subsets of price levels is limited to a defined total amount of risk.

35. The computer implemented method of claim 34 further comprising:
prior to the conclusion of the first and second transactions, determining, by the processor, if the total amount of risk has been depleted by the reduction based on the first transaction and acting, by the processor, on the second transaction in accordance therewith.

36. The computer implemented method of claim 35, wherein the acting further comprises rejecting the second transaction when the total amount of risk has been depleted.

37. The computer implemented method of claim 29 further comprising allocating, by the processor the amount of risk based on a credit rating of the market participant, an estimated maximum liability of the market participant, or a combination thereof.

38. The computer implemented method of claim 29, wherein the reducing further comprises determining a first amount of risk associated with the first transaction and reducing the allocated amount of risk in accordance therewith.

39. The computer implemented method of claim 38, wherein the first amount is fixed.

40. The computer implemented method of claim 38, wherein the allocated amount of risk is measured in quantity units, the first amount being determined based on a quantity specified by the first transaction.

41. The computer implemented method of claim 38, wherein the first amount is computed based on the first transaction.

42. The computer implemented method of claim 29, further comprising transmitting, by the processor, a warning message to the market participant that the allocated amount of risk is nearing depletion when the allocated amount of risk falls below a threshold amount of risk.

43. The computer implemented method of claim 29, further comprising transmitting, by the processor, a message to the market participant when the allocated amount of risk has been depleted.

44. The computer implemented method of claim 29, wherein the acting further comprises rejecting the second transaction when the allocated amount of risk of all of the subsets of price levels which contain the second price level has been depleted.

45. The computer implemented method of claim 29 further comprising:
determining, by the processor, that the first transaction has been concluded and increasing the allocated amount risk of all of the subsets of price levels which contain the first price level based thereon.

46. The computer implemented method of claim 29 further comprising:
increasing, by the processor, the allocated amount of risk of all of the subsets of price levels which contain the first price level after an elapse of a period of time after receipt of the first transaction.

47. The computer implemented method of claim 29 wherein the first transaction may be concluded by at least partially matching with another proposed transaction at least partially counter thereto, or by being canceled.

48. The computer implemented method of claim 29 further comprising monitoring, by the processor, for fluctuations of the stored allocated amount of risk and acting, by the processor, on the second transaction in accordance therewith when the magnitude of the fluctuations exceeds a threshold.

49. The computer implemented method of claim 29 wherein the market is operative to attempt to match an incoming transaction for the financial product with a previously received but unsatisfied transaction counter thereto, the market being characterized by a market parameter which may change over time based on results of the attempted matching, the market being further operative to at least interrupt the attempted matching of incoming transactions when a rate of change of the market parameter deviates from a threshold, the method further comprising:
determining, by the processor based on the threshold for which a deviation of the market parameter therefrom will cause the market to at least interrupt the attempted matching, the number of price levels of the set of price levels within each of the plurality of subsets of price levels.

50. The computer implemented method of claim 49 wherein the threshold comprises a magnitude of a number of price levels a last traded price of the financial product may change over a defined period of time.

51. The computer implemented method of claim 49 further comprising:
allowing, by the processor when attempted matching of incoming transactions has at least been interrupted, a market participant to cancel previously submitted transactions which have not yet been concluded.

52. The computer implemented method of claim 49 wherein the market parameter comprises a bid price of the product, an ask price of the product, a last traded price of the product, a last traded quantity of the product, a volatility of the product, market attribute, delta, present value, or a combination thereof.

53. The computer implemented method of claim 29 wherein the market is operative to attempt to match an incoming transaction for the financial product with a previously received but unsatisfied transaction counter thereto, the market being characterized by a market parameter which may change over time based on results of the attempted matching, the method further comprising:
allowing, by the processor, the market participant to specify a rate of change of the market parameter, the number of price levels of the set of price levels within each of the plurality of subsets of price levels being based thereon.

54. The computer implemented method of claim 53 wherein market parameter comprises volatility, profit/loss, or a combination thereof.

55. A system for protecting a market participant participating in a market for a financial product, the market comprising a set of price levels at which transactions for the financial product may be proposed, the system comprising:
means for allocating, for each of a plurality of market participants, an amount of risk to each of a plurality of subsets of price levels of the set of price levels;
means for receiving, from a first market participant of the plurality of market participants, a first transaction at a first price level within a first subset of price levels, the first transaction having been proposed by the market participant but not yet matched with another proposed transaction counter thereto;
means for reducing, based on the first transaction, the allocated amount of risk of the first market participant associated with all of the subsets of price levels of the set of price levels containing the first price level;
means for receiving a second transaction at a second price level proposed but not yet matched with another proposed transaction counter thereto, the second transaction having been proposed prior to the conclusion of the first transaction;
means for determining all of the subsets of price levels of the set of price levels which contain the second price level; and
means for, prior to the conclusion of the first and second transactions, determining if the allocated amount of risk of all of the subsets of price levels which contain the second price level has been depleted by the reduction based on the first transaction and acting, by the processor, on the second transaction in accordance therewith.

56. The system of claim 1 wherein the market is operative to attempt to match an incoming transaction for the financial product with a previously received but unsatisfied transaction counter thereto, the market being characterized by a market parameter which may change over time based on results of the attempted matching, the market being further operative to at least interrupt the attempted matching of incoming transactions when a rate of change of the market parameter deviates from a threshold, the system further comprising:
means for determining, based on the threshold for which a deviation of the market parameter therefrom will cause the market to at least interrupt the attempted matching, the number of price levels of the set of price levels within each of the plurality of subsets of price levels.
